(19) United States
(12) Patent Application Publication
(10) Pub. No.: US 2015/0111611 A1
(43) Pub. Date: Apr. 23, 2015

(54) MOBILE TERMINAL AND CONTROL METHOD THEREOF

(71) Applicant: LG Electronics Inc., Seoul (KR)

(72) Inventors: Yunjueng Mhun, Seoul (KR); Hyemi Jung, Seoul (KR); Jinhae Choi, Seoul (KR); Jumin Chi, Seoul (KR); Yoonseok Yang, Seoul (KR); Jongseok Park, Seoul (KR); Suegyoung Kim, Seoul (KR)

(73) Assignee: LG Electronics Inc., Seoul (KR)

(21) Appl. No.: 14/185,381

(22) Filed: Feb. 20, 2014

(30) Foreign Application Priority Data
Oct. 21, 2013 (KR) 10-2013-0125466

(51) Int. Cl. G08B 5/36; H04M 1/02

(52) U.S. Cl. CPC G08B 5/36; H04M 1/0264
USPC 455/556.1

(57) ABSTRACT

A mobile terminal and a control method thereof are provided. The mobile terminal includes a case; at least one optical output unit configured to emit light with at least one color, the at least one optical output unit being provided in at least one positions of a front side and a rear side of the case; and a controller configured to control an operation of the at least one optical output unit based on obtained information such that an optical output unit to emit light, among the at least one optical output unit, an emitting color of the optical output unit to emit light, an emitting duration of the optical output unit to emit light, and an emitting pattern of the optical output unit to emit light is controlled differently according to the obtained information.

### CROSS-REFERENCE TO RELATED APPLICATIONS

Pursuant to 35 U.S.C. §119(a), this application claims the benefit of earlier filing date and right of priority to Korean Patent Application No. 10-2013-0125466, filed on Oct. 21, 2013, the contents of which are incorporated by reference herein in their entirety.

### TECHNICAL FIELD

The present invention relates to a mobile terminal and, more particularly, to a mobile terminal capable of controlling an operation of an optical output unit based on obtained information and a control method thereof.

### DISCUSSION OF THE RELATED ART

As functions of terminals such as personal computers, laptop computers, cellular phones diversify, the terminals become multimedia players having multiple functions for capturing pictures or moving images, playing music, moving image files and games and receiving broadcasting programs.

Terminals can be categorized as mobile terminals and stationary terminals. The mobile terminals can be further comprised of handheld terminals and vehicle mount terminals according to whether users can personally carry the terminals. Conventional terminals including mobile terminals provide an increasing number of complex and various functions.

To support and enhance the increasing number of functions in a terminal, improving a structural part and/or a software part of the terminal would be desirable.

### SUMMARY

An aspect of the present invention provides a mobile terminal capable of controlling an operation of an optical output unit based on obtained information and a control method thereof.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention.

FIG. 1 is a block diagram of a mobile terminal according to an embodiment;

FIG. 2 is a front perspective view of a mobile terminal related to an embodiment;

FIG. 3 is a rear perspective view of the mobile terminal of FIG. 2;

FIG. 4 is a rear perspective view of a mobile terminal according to another embodiment;

FIGS. 5(a) and 5(b) are perspective views of a mobile terminal according to another embodiment;

FIG. 6 is a flow chart illustrating an operation process of the mobile terminal of FIG. 1;

FIG. 7 is a flow chart illustrating an operation process of the mobile terminal of FIG. 1 according to another embodiment;

FIGS. 8 through 12 are views illustrating operations of the mobile terminal of FIG. 1 according to an embodiment; and

FIGS. 13 through 36 are views illustrating operations of the mobile terminal of FIG. 1 according to various embodiments.

### DETAILED DESCRIPTION

Arrangements and embodiments may now be described more fully with reference to the accompanying drawings, in which exemplary embodiments may be shown. Embodiments may, however, be embodied in many different forms and should not be construed as being limited to embodiments set forth herein; rather, embodiments may be provided so that this disclosure will be thorough and complete, and will fully convey the concept to those skilled in the art.

A mobile terminal may be described below with reference to the accompanying drawings. In the following description, suffixes “module” and “unit” may be given to components of the mobile terminal in consideration of only facilitation of description and do not have meanings or functions discriminated from each other.

The mobile terminal may include a cellular phone, a smart phone, a laptop computer, a digital broadcasting terminal, personal digital assistants (PDA), a portable multimedia player (PMP), a navigation system and/or so on.

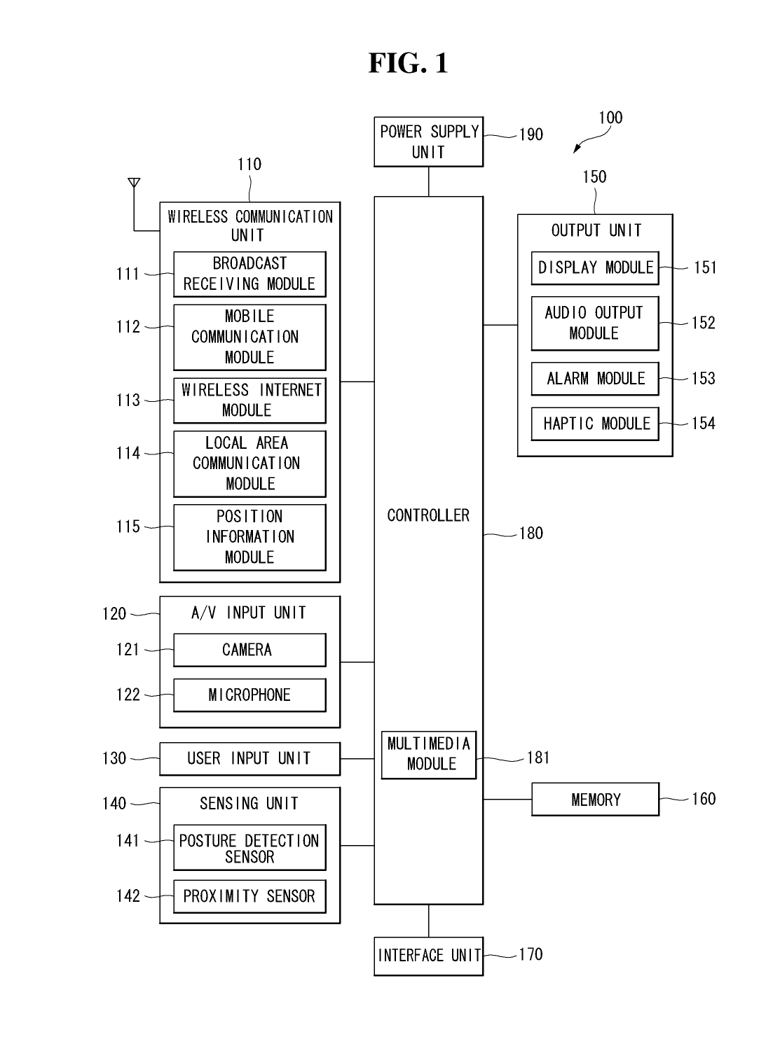

FIG. 1 is a block diagram of a mobile terminal according to an embodiment. Other embodiments, configurations and arrangements may also be provided.

As shown, the mobile terminal 100 may include a wireless communication unit 110 (or radio communication unit), an audio/video (A/V) input unit 120, a user input unit 130, a sensing unit 140, an output unit 150, a memory 160, an interface 170, a controller 180, and a power supply 190. The components shown in FIG. 1 may be essential parts and/or a number of components included in the mobile terminal 100 may vary. Components of the mobile terminal 100 may now be described.

The wireless communication unit 110 may include at least one module that enables radio communication between the mobile terminal 100 and a radio communication system or between the mobile terminal 100 and a network in which the mobile terminal 100 is located. For example, the wireless communication unit 110 may include a broadcasting receiving module 111, a mobile communication module 112, a wireless Internet module 113, a short range communication module 114 (or local area communication module), and a location information module 115 (or position information module).

The broadcasting receiving module 111 may receive broadcasting signals and/or broadcasting related information from an external broadcasting management server through a broadcasting channel. The broadcasting channel may include a satellite channel and a terrestrial channel, and the broadcasting management server may be a server that generates and transmits broadcasting signals and/or broadcasting related information or a server that receives previously created broadcasting signals and/or broadcasting related information and transmits the broadcasting signals and/or broadcasting related information to a terminal.

The broadcasting signals may include not only TV broadcasting signals, radio broadcasting signals, and data broadcasting signals but also signals in the form of a combination of a TV broadcasting signal and a radio broadcasting signal. The broadcasting related information may be information on a broadcasting channel, a broadcasting program or a broadcasting service provider, and may be provided even through a mobile communication network. In the latter case, the broadcasting related information may be received by the mobile communication module 112.

The broadcasting related information may exist in various forms. For example, the broadcasting related information may exist in the form of an electronic program guide (EPG) of a digital multimedia broadcasting (DMB) system or in the form of an electronic service guide (ESG) of a digital video broadcast-handheld (DVB-H) system.

The broadcasting receiving module 111 may receive broadcasting signals using various broadcasting systems. More particularly, the broadcasting receiving module 111 may receive digital broadcasting signals using digital broadcasting systems such as a digital multimedia broadcasting-terrestrial (DMB-T) system, a digital multimedia broadcasting-satellite (DMB-S) system, a media forward link only (MediaFLO) system, a DVB-H and integrated services digital broadcast-terrestrial (ISDB-T) systems. The broadcasting receiving module 111 may receive signals from broadcasting systems providing broadcasting signals other than the above-described digital broadcasting systems.

The broadcasting signals and/or broadcasting related information received through the broadcasting receiving module 111 may be stored in the memory 160. The mobile communication module 112 may transmit/receive a radio signal to/from at least one of a base station, an external terminal and a server on a mobile communication network. The radio signal may include a voice call signal, a video telephony call signal or data in various forms according to transmission and reception of text/multimedia messages.

The wireless Internet module 113 may correspond to a module for wireless Internet access and may be included in the mobile terminal 100 or may be externally attached to the mobile terminal 100. Wireless LAN (WLAN or Wi-Fi), wireless broadband (Wibro), world interoperability for microwave access (Wimax), high speed downlink packet access (HSDPA) and so on may be used as a wireless Internet technique.

The short range communication module 114 may correspond to a module for short range communication. Further, Bluetooth®, radio frequency identification (RFID), infrared data association (IrDA), ultra wideband (UWB) and/or ZigBee® may be used as a short range communication technique.

The location information module 115 may confirm or obtain a location or a position of the mobile terminal 100. The location information module 115 may obtain position information by using a global navigation satellite system (GNSS). The GNSS is a terminology describing a radio navigation satellite system that revolves around the earth and transmits reference signals to predetermined types of radio navigation receivers such that the radio navigation receivers can determine their positions on the earth's surface or near the earth's surface. The GNSS may include a global positioning system (GPS) of the United States, Galileo of Europe, a global orbiting navigational satellite system (GLONASS) of Russia, COMPASS of China, and a quasi-zenith satellite system (QZSS) of Japan, for example.

A global positioning system (GPS) module is a representative example of the location information module 115. The GPS module may calculate information on distances between one point or object and at least three satellites and information on a time when distance information is measured and apply trigonometry to the obtained distance information to obtain three-dimensional position information on the point or object according to latitude, longitude and altitude at a predetermined time.

A method of calculating position and time information using three satellites and correcting the calculated position and time information using another satellite may also be used. Additionally, the GPS module may continuously calculate a current position in real time and calculate velocity information using the location or position information.

The A/V input unit 120 may input (or receive) an audio signal and/or a video signal. The A/V input unit 120 may include a camera 121 and a microphone 122. The camera 121 may process image frames of still images or moving images obtained by an image sensor in a video telephony mode or a photographing mode. The processed image frames may be displayed on a display 151, which may be a touch screen.

The image frames processed by the camera 121 may be stored in the memory 160 or may be transmitted to an external device through the wireless communication unit 110. The mobile terminal 100 may also include at least two cameras 121.

The microphone 122 may receive an external audio signal in a call mode, a recording mode and/or a speech recognition mode, and the microphone 122 may process the received audio signal into electric audio data. The audio data may then be converted into a form that can be transmitted to a mobile communication base station through the mobile communication module 112 and output in the call mode. The microphone 122 may employ various noise removal algorithms (or noise canceling algorithm) for removing or reducing noise generated when the external audio signal is received.

The user input unit 130 may receive input data for controlling operation of the mobile terminal 100 from a user. The user input unit 130 may include a keypad, a dome switch, a touch pad (constant voltage/capacitance), a jog wheel, a jog switch and/or so on.

The sensing unit 140 may sense a current state of the mobile terminal 100, such as an open/close state of the mobile terminal 100, a position of the mobile terminal 100, whether a user touches the mobile terminal 100, a direction of the mobile terminal 100, and acceleration/deceleration of the mobile terminal 100, and the sensing unit 140 may generate a sensing signal for controlling operation of the mobile terminal 100. For example, in an example of a slide phone, the sensing unit 140 may sense whether the slide phone is opened or closed. Further, the sensing unit 140 may sense whether the power supply 190 supplies power and/or whether the interface 170 is connected to an external device. The sensing unit 140 may also include a proximity sensor 141. The sensing unit 140 may sense a motion of the mobile terminal 100.

The output unit 150 may generate visual, auditory and/or tactile output, and the output unit 150 may include the display 151, an audio output module 152, an alarm 153 and a haptic module 154. The display 151 may display information processed by the mobile terminal 100. The display 151 may display a user interface (UI) and/or a graphic user interface (GUI) related to a telephone call when the mobile terminal 100 is in the call mode. The display 151 may also display a captured and/or received image, a UI or a GUI when the mobile terminal 100 is in the video telephony mode or the photographing mode.

The display 151 may include at least one of a liquid crystal display, a thin film transistor liquid crystal display, an organic light-emitting diode display, a flexible display and/or a three-dimensional display. The display 151 may be of a transparent type or a light transmissive type. That is, the display 151 may include a transparent display.

The transparent display may be a transparent liquid crystal display. A rear structure of the display 151 may also be of a light transmissive type. Accordingly, a user may see an object located behind the body (of the mobile terminal 100) through the transparent area of the body of the mobile terminal 100 that is occupied by the display 151.

The mobile terminal 100 may also include at least two displays 151. For example, the mobile terminal 100 may include a plurality of displays 151 that are arranged on a single face at a predetermined distance or integrated displays. The plurality of displays 151 may also be arranged on different sides.

When the display 151 and a sensor sensing touch (hereafter referred to as a touch sensor) form a layered structure that is referred to as a touch screen, the display 151 may be used as an input device in addition to an output device. The touch sensor may be in the form of a touch film, a touch sheet, and/or a touch pad, for example.

The touch sensor may convert a variation in pressure applied to a specific portion of the display 151 or a variation in capacitance generated at a specific portion of the display 151 into an electric input signal. The touch sensor may sense pressure of touch as well as position and area of the touch.

When the user applies a touch input to the touch sensor, a signal corresponding to the touch input may be transmitted to a touch controller. The touch controller may then process the signal and transmit data corresponding to the processed signal to the controller 180. Accordingly, the controller 180 may detect a touched portion of the display 151.

The proximity sensor 141 (of the sensing unit 140) may be located in an internal region of the mobile terminal 100, surrounded by the touch screen, and/or near the touch screen. The proximity sensor 141 may sense an object approaching a predetermined sensing face or an object located near the proximity sensor 141 using an electromagnetic force or infrared rays without having mechanical contact. The proximity sensor 141 may have a lifetime longer than a contact sensor and may thus have a wide application in the mobile terminal 100.

The proximity sensor 141 may include a transmission type photo-electric sensor, a direct reflection type photo-electric sensor, a mirror reflection type photo-electric sensor, a high-frequency oscillating proximity sensor, a capacitive proximity sensor, a magnetic proximity sensor, and/or an infrared proximity sensor. A capacitive touch screen may be constructed such that proximity of a pointer is detected through a variation in an electric field according to the proximity of the pointer. The touch screen (touch sensor) may be classified as a proximity sensor 141.

For ease of explanation, an action of the pointer approaching the touch screen without actually touching the touch screen may be referred to as a proximity touch and an action of bringing the pointer into contact with the touch screen may be referred to as a contact touch. The proximity touch point of the pointer on the touch screen may correspond to a point of the touch screen at which the pointer is perpendicular to the touch screen.

The proximity sensor 141 may sense the proximity touch and a proximity touch pattern (e.g., a proximity touch distance, a proximity touch direction, a proximity touch velocity, a proximity touch time, a proximity touch position, a proximity touch moving state, etc.). Information corresponding to the sensed proximity touch action and proximity touch pattern may then be displayed on the touch screen.

The audio output module 152 may output audio data received from the wireless communication unit 110 or stored in the memory 160 in a call signal receiving mode, a telephone call mode or a recording mode, a speech recognition mode and a broadcasting receiving mode. The audio output module 152 may output audio signals related to functions, such as a call signal incoming tone and a message incoming tone, performed in the mobile terminal 100. The audio output module 152 may include a receiver, a speaker, a buzzer, and/or the like. The audio output module 152 may output sounds through an earphone jack. The user may hear the sounds by connecting an earphone to the earphone jack.

The alarm 153 may output a signal for indicating generation of an event of the mobile terminal 100. For example, an alarm may be generated when receiving a call signal, receiving a message, inputting a key signal, and/or inputting a touch. The alarm 153 may also output signals in forms different from video signals or audio signals, for example, a signal for indicating generation of an event through vibration. The video signals and/or the audio signals may also be output through the display 151 or the audio output module 152.

The haptic module 154 may generate various haptic effects that the user can feel. One example of the haptic effects is vibration. An intensity and/or pattern of vibration generated by the haptic module 154 may also be controlled. For example, different vibrations may be combined and output or may be sequentially output.

The haptic module 154 may generate a variety of haptic effects including an effect of stimulus according to an arrangement of pins vertically moving against a contact skin surface, an effect of stimulus according to a jet force or sucking force of air through a jet hole or a sucking hole, an effect of stimulus of rubbing the skin, an effect of stimulus according to contact of an electrode, an effect of stimulus using an electrostatic force, and an effect according to a reproduction of cold and warmth using an element capable of absorbing or radiating heat in addition to vibrations.

The haptic module 154 may not only transmit haptic effects through direct contact but may also allow the user to feel haptic effects through a kinesthetic sense of the user's fingers or arms. The mobile terminal 100 may also include a plurality of haptic modules 154.

The memory 160 may store a program for operations of the controller 180 and/or temporarily store input/output data such as a phone book, messages, still images, and/or moving images. The memory 160 may also store data about vibrations and sounds in various patterns that are output from when a touch input is applied to the touch screen.

The memory 160 may include at least a flash memory, a hard disk type memory, a multimedia card micro type memory, a card type memory, such as SD or XD memory, a random access memory (RAM), a static RAM (SRAM), a read-only memory (ROM), an electrically erasable programmable ROM (EEPROM), a programmable ROM (PROM) magnetic memory, a magnetic disk and/or an optical disk. The mobile terminal 100 may also operate in relation to a web storage that performs a storing function of the memory 160 on the Internet.

The interface 170 may serve as a path to external devices connected to the mobile terminal 100. The interface 170 may receive data from the external devices or power and transmit the data or power to internal components of the mobile terminal 100 or transmit data of the mobile terminal 100 to the external devices. For example, the interface 170 may include a wired/wireless headset port, an external charger port, a wired/wireless data port, a memory card port, a port for connecting a device having a user identification module, an audio I/O port, a video I/O port, and/or an earphone port.

The interface 170 may also interface with a user identification module that is a chip that stores information for authenticating authority to use the mobile terminal 100. For example, the user identification module may be a user identify module (UIM), a subscriber identify module (SIM) and/or a universal subscriber identify module (USIM). An identification device (including the user identification module) may also be manufactured in the form of a smart card. Accordingly, the identification device may be connected to the mobile terminal 100 through a port of the interface 170.

The interface 170 may also be a path through which power from an external cradle is provided to the mobile terminal 100 when the mobile terminal 100 is connected to the external cradle or a path through which various command signals input by the user through the cradle are transmitted to the mobile terminal 100. The various command signals or power input from the cradle may be used as signals for confirming whether the mobile terminal 100 is correctly set in the cradle.

The controller 180 may control overall operations of the mobile terminal 100. For example, the controller 180 may perform control and processing for voice communication, data communication and/or video telephony. The controller 180 may also include a multimedia module 181 for playing multimedia. The multimedia module 181 may be included in the controller 180 or may be separated from the controller 180.

The controller 180 may perform a pattern recognition process capable of recognizing handwriting input or picture-drawing input applied to the touch screen as characters or images. The power supply 190 may receive external power and internal power and provide power required for operations of the components of the mobile terminal 100 under control of the controller 180.

According to hardware implementation, embodiments may be implemented using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and/or electrical units for executing functions. Embodiments may be implemented by the controller 180.

According to software implementation, embodiments such as procedures or functions may be implemented with a separate software module that executes at least one function or operation. Software codes may be implemented according to a software application written in an appropriate software language. The software codes may be stored in the memory 160 and executed by the controller 180.

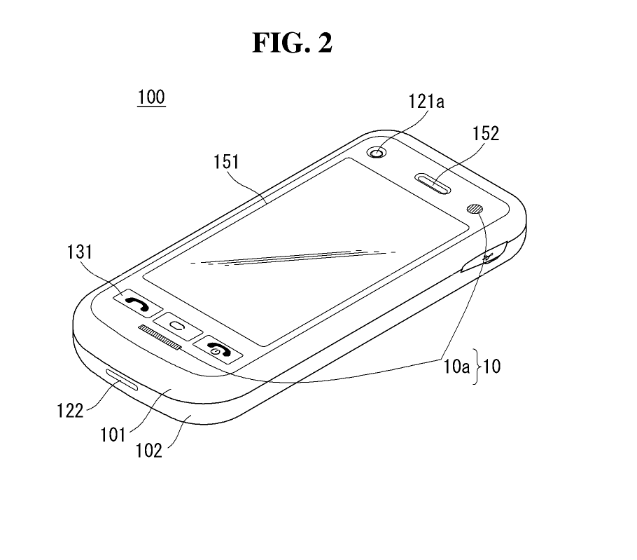

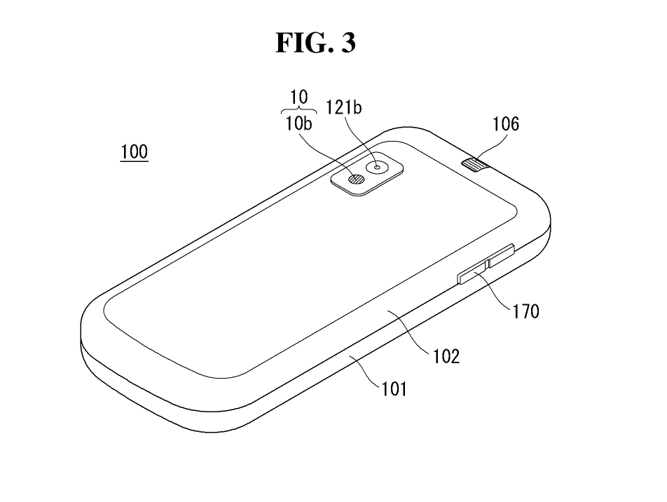

FIG. 2 is a front perspective view of a mobile terminal related to an embodiment, and FIG. 3 is a rear perspective view of the mobile terminal of FIG. 2.

As illustrated in FIGS. 2 and 3, the mobile terminal 100 according to an embodiment may have a bar-type body. The bar-type body may be formed by injection-molding a synthetic resin or may be formed of a metal, for example, stainless steel (STS), titanium, or the like. However, the present disclosure is not limited thereto and may be applicable to various structures such as a slide type, a folder type, a swing type, a swivel type, and the like, in which two or more bodies are combined to be relatively movable.

In an assembled state, a front case 101 and a battery cover 102 may be exposed to the outside.

The front case 101 may be a portion of a front side of the mobile terminal 100. A display 151, an audio output unit 152, a front camera 121a, a user input unit 131, a microphone 122, and the like, may be disposed in the front case 101.

The display 151 may be positioned in the front side of the front case 101. The display 151 may display various types of information required for an operation of the mobile terminal 100. The display 151 may display a 2D image and/or a 3D image.

The audio output unit 152 may be a speaker outputting a reception sound, or the like. A plurality of audio output units 151 may be provided. For example, a plurality of audio output units 152 for outputting a reception sound or a bell sound may be provided.

The front camera 121a may be positioned to capture a user. For example, the user may perform a video call with a different user based on his or her image captured through the front camera 121a.

The user input unit 131 may be manipulated to receive a command for controlling an operation of the mobile terminal 100 and may include a plurality of manipulation units. The user input unit 131 may be sensed in a capacitive manner, and may generate light when a user input is applied thereto.

The user input unit 131 may be generally referred to as a manipulating portion and any method may be employed if it is a tactile manner allowing the user to perform manipulation with a tactile feeling. For example, the user input unit 131 may be a physical button.

The user input unit may be allocated a function having high frequency or a major function. For example, functions such as starting and terminating the mobile terminal 100 and/or an application, volume adjustment, and the like, may be allocated to the user input unit 131.

The microphone 122 may be a device for obtaining a user voice, and the like. The microphone 122 may be positioned in a lower portion of the mobile terminal 100.

An optical output unit 10 may be provided in an outer portion of the mobile terminal 100. The optical output unit 10 may selectively emit light according to a control signal from the controller 180. The optical output unit 10 may be configured as LEDs and/or luminous bodies having various colors.

The optical output unit 10 may be provided in at least one position of an outer surface of the mobile terminal 100. Namely, the optical output unit 10 may be provided in at least one position among a front side, a rear side, and a lateral side. For example, the optical output unit 10 may include a first optical output unit 10a provided in the front side of the mobile terminal 100.

The optical output unit 10 may be controlled by a control signal from the controller 180 based on a user state and/or a state therearound. For example, an operation of the optical output unit 10 may be controlled based on at least one of user's clothes, a user's voice, brightness of surroundings, and an ambient color. The controller 180 may obtain information regarding user's clothes, and the like, through the camera 121. Based on the information obtained through the camera 121, the controller 180 may determine whether to emit light of the optical output unit 10, a degree of light emission, a color of light emission, and the like.

As illustrated in FIG. 3, a battery cover 102 may be exposed to the rear side of the mobile terminal 100 according to embodiment. An earphone jack 171, an antenna 124, a rear camera 121b, a side key button 170, and a second optical output unit 10b may be positioned in the rear side exposing the battery camera 102.

The earphone jack 171 may output a sound output from the mobile terminal 100 through an earphone. The earphone jack 171 may include a terminal for receiving a manipulation signal for controlling a function of the mobile terminal through a button provided in the earphone, as well as a terminal for transmitting an audio signal.

The antenna 124 may be used to obtain a broadcast signal for viewing DMB, or the like. For example, in order to smoothly receive a broadcast signal, the user may draw the antenna 124 out of the terminal body to use it.

The rear camera 121b may be positioned in the rear side of the mobile terminal 100. The rear camera 121b may capture a stereoscopic image. For example, the rear camera 121b may capture an image for a left eye and an image for a right eye.

A camera flash 123 may be positioned to be adjacent to the rear camera 121b. The camera flash 123 may operate when an image is captured.

The side key button 170 may be positioned in the lateral side of the mobile terminal 100. A sound volume of the mobile terminal 100 may be adjusted through an operation of pushing an upper or lower side of the volume adjustment switch 170.

The second optical output unit 10b may operate based on a control signal from the controller 180 as mentioned above. The second optical output unit 10b may also serve as a flash of the camera 121b.

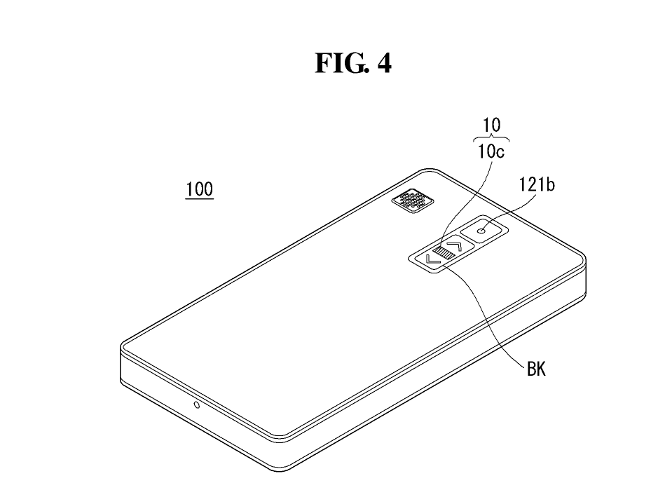

FIG. 4 is a rear perspective view of a mobile terminal according to another embodiment.

As illustrated in FIG. 4, the mobile terminal according to another embodiment may include a manipulation button BK positioned in the rear side thereof. For example, at least a pair of buttons may be provided in an upper portion in the center of the rear side of the mobile terminal 100.

The manipulation button BK may replace a button positioned in the lateral side of the mobile terminal. Namely, the role of the button positioned in the lateral side of the mobile terminal 100 may be replaced by the manipulation button BK positioned in the rear side of the mobile terminal 100. Since the manipulation button KB is positioned in the rear side of the mobile terminal 100, the user may more conveniently manipulate it with the mobile terminal 100 held in his or her hands.

A third optical output unit 10c may be positioned to be adjacent to the manipulation button BK. For example, the third optical output unit 10c may be provided in at least one position among upper, lower, and lateral sides of the manipulation button BK. The controller 180 may adjust emitting of the third optical output unit 10c based on an image of surroundings captured by the camera 121b.

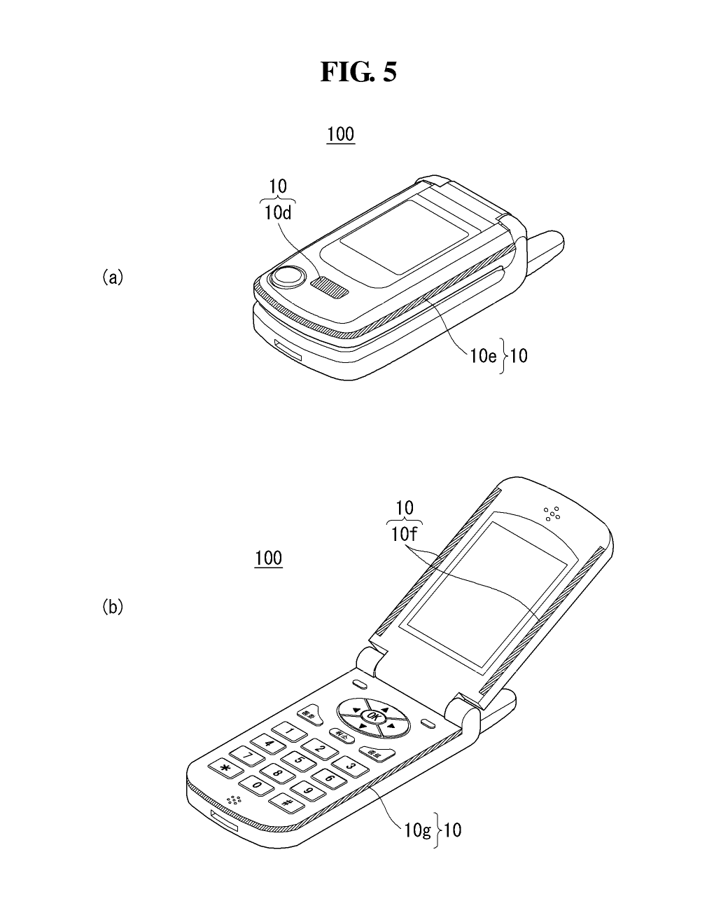

FIGS. 5(a) and 5(b) are perspective views of a mobile terminal according to another embodiment.

As illustrated in FIGS. 5(a) and 5(b), the mobile terminal 100 according to another embodiment may be a folder-type mobile terminal.

As illustrated in 5(a), a fourth optical output unit 10d may be positioned in a front side of the folder-type mobile terminal 100. A fifth optical output unit 10e may be positioned in a lateral side of the mobile terminal 100. Due to the presence of the fourth and/or fifth optical output units 10d and 10e, information may be transmitted through emitting even when the mobile terminal 100 is folded.

As illustrated in FIG. 5(b), a sixth optical output unit 10f and a seventh optical output unit 10g may be positioned at an inner side of the mobile terminal 100. The sixth and seventh optical output units 10f and 10g may selectively emit light in a state in which the mobile terminal 100 is open. The controller 180 may selectively operate the fourth and fifth optical output units 10d and 10e or the sixth and seventh optical output units 10f and 10g according to a current folded or unfolded state of the mobile terminal 100. Namely, when the mobile terminal 100 is unfolded, the sixth and seventh optical output units 10f and 10g may emit light, and when the mobile terminal 100 is folded, the fourth and fifth optical output units 10d and 10e may emit light.

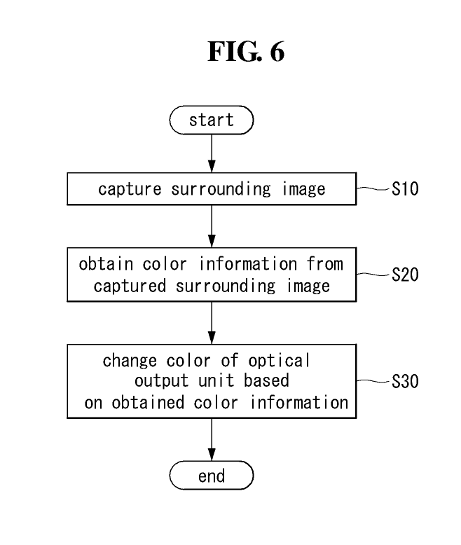

FIG. 6 is a flow chart illustrating an operation process of the mobile terminal of FIG. 1.

As illustrated in FIG. 6, the controller 180 of the mobile terminal 100 according to an embodiment may capture an image of surroundings (S10).

The image of surroundings may be captured by the camera 121. For example, the image of surroundings may be captured by the camera 121 positioned in the front side and/or the rear side of the mobile terminal 100.

The captured image of surroundings may vary according to a current state of the mobile terminal 100. For example, in a case in which the user of the mobile terminal 100 captures his or her own image, the image may be an image captured through a front camera of the mobile terminal 100, and in a case in which the user of the mobile terminal 100 captures someone else and/or an external image, the image may be an image captured by a rear camera of the mobile terminal 100.

Color information may be obtained from the captured image of surroundings (S20).

The color information may be information reflecting an atmosphere of the captured image. For example, the color information may be information such as whether the user is dressed in bright color or dark color, or the like.

The controller 180 may estimate the mobile terminal user's feeling, mood, or the like, based on the obtained color information. Namely, the controller 180 may obtain user's feeling information.

A color of the optical output unit 10 may be changed based on the obtained color information (S30).

The color information may reflect a usage environment of the mobile terminal 100. For example, the color information may reflect the mobile terminal 100 user's feeling. The usage information of the mobile terminal 100 and/or user's feeling may be estimated through user's clothes, or the like.

The controller 180 may control an operation of the optical output unit 10 based on the usage environment and/or the user's feeling. For example, the controller 180 may change a color of the optical output unit 10 into a color similar to the color of the user's clothes.

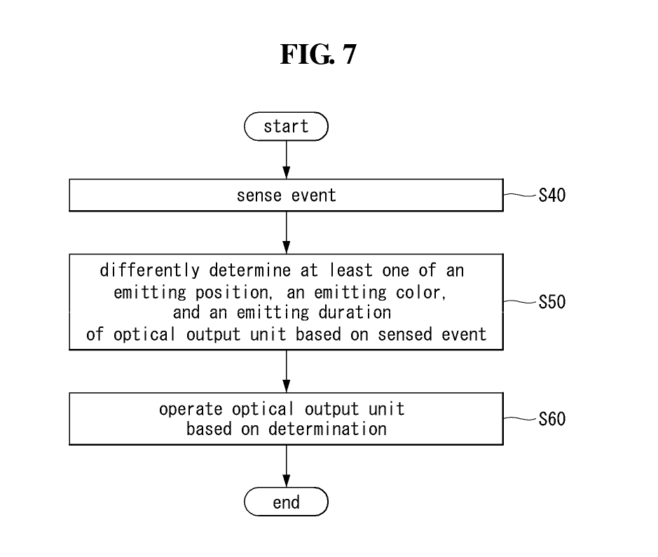

FIG. 7 is a flow chart illustrating an operation process of the mobile terminal of FIG. 1 according to another embodiment;

As illustrated in FIG. 7, the controller 180 of the mobile terminal 100 according to another embodiment may sense an event (S40).

The event may be various situations that may occur in the process of using the mobile terminal 100. For example, the event may include an event of capturing an image by using the camera 121 of the mobile terminal 100, an event of receiving and transmitting a call by using the mobile terminal 100, an event of receiving and transmitting a message by using the mobile terminal 100, an event of receiving and transmitting various types of information such as stock, weather, and the like, by using the mobile terminal 100.

An event may be collected in different manners according to a type of the corresponding event. For example, the event using the camera 121 may be collected through an operation of the camera 121, and an information event such as stock, weather, and the like, may be collected through the wireless communication unit 110.

The controller 180 may determine at least one of an emitting position, an emitting color, and an emitting duration of the optical output unit 10 differently based on the sensed event (S50), and operate the optical output unit 10 based on the determination (S60).

The controller 180 may control the optical output unit 10 to operate differently according to an event. Thus, the user may easily recognize which event has currently occurred by simply viewing an operation of the optical output unit 10.

The controller 180 may control at least one of an emitting position, an emitting color, and an emitting duration of the optical output unit 10 differently. For example, the controller 180 may control the optical output unit 10 in the front side and/or the rear side of the mobile terminal 100 to emit light according to a direction in which a particular event occurs. The controller 180 may change a color according to a type of event.

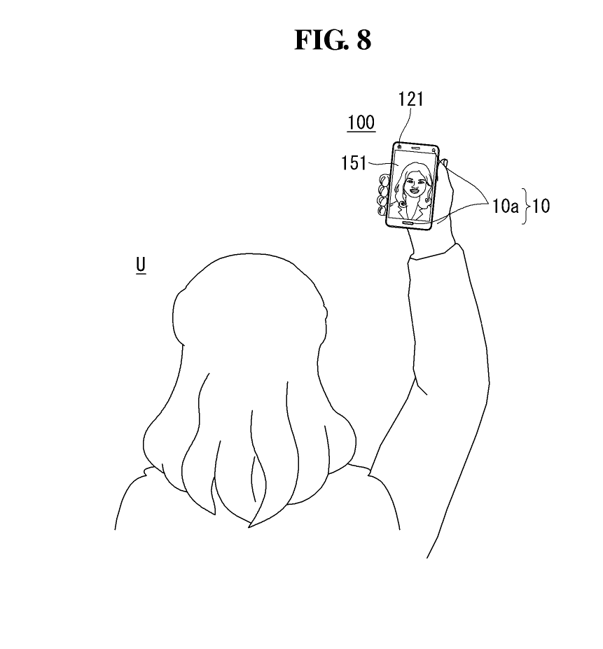

FIGS. 8 through 12 are views illustrating operations of the mobile terminal of FIG. 1 according to an embodiment.

As illustrated in FIGS. 8 through 12, the controller 180 of the mobile terminal 100 according to an embodiment may change at least one of emitting and color of the optical output unit 10 based on a captured image.

As illustrated in FIG. 8, the user U may capture an image by using the mobile terminal 100. For example, the user U may capture an image of herself by using the camera 121 positioned in the front side of the mobile terminal 100. The first optical output unit 10a may be positioned in the front side of the mobile terminal 100.

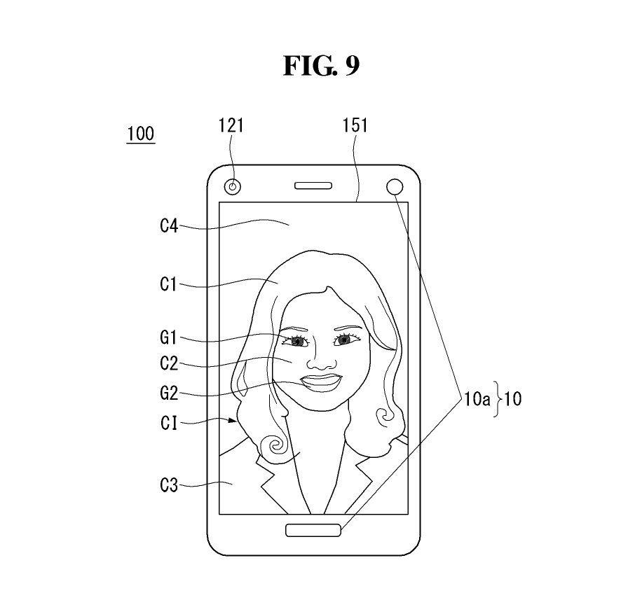

As illustrated in FIG. 9, a captured image C1 being captured by using camera 121 may be displayed on the display unit 151.

The captured image C1 may include various images. For example, the captured image C1 may include at least one of a first captured image C1 obtained by capturing the user's head, a second captured image c2 obtained by capturing the user's face, a third captured image C3 obtained by capturing the user's clothes, and a fourth captured image C4 obtained capturing a background.

The captured image C1 may include an image of a user's state. For example, the captured image C1 may include a first condition image G1 obtained by capturing a shape of the user's eyes and a second condition image G2 obtained by capturing a shape of the user's mouth.

The controller 180 may analyze at least a portion of the captured image C1. For example, the controller 180 may sense the user's hair color through the first captured image C1. The controller 180 may sense a user's skin color through the second captured image C2. The controller 180 may sense a color and/or form of the user's clothes through the third captured image C3. The controller 180 may sense a user's feeling state through the first and second condition images G1 and G2.

The controller 180 may control the optical output unit 10 to operate according to the series of a color corresponding to the color of the user's clothes and/or form. For example, in a case in which the user's clothes being imaged is blue, the controller 180 may control the optical output unit 10 to emit a color of blue series. The color of the optical output unit 10 may be changed according to a color of the clothes of a subject being imaged.

The controller 180 may control the first optical output unit 10a positioned in the front side of the mobile terminal 100 and the second optical output unit 10b positioned in the rear side thereof to emit different colors. For example, in a case in which the user facing the front side of the mobile terminal 100 is dressed in blue and someone else facing the rear side of the mobile terminal 100 is dressed in red, the first optical output unit 10a of the front side of the mobile terminal 100 may emit light of blue series and the second optical output unit 10b in the rear side of the mobile terminal 100 may emit light of red series. Namely, the first and second optical output units 10a and 10b may respectively emit a first color according to color information of an image captured in the front side and a second color according to color information of the image captured in the rear side, differently.

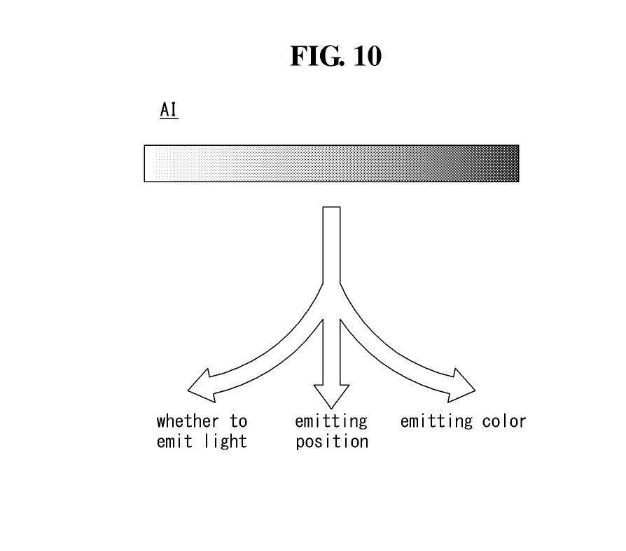

As illustrated in FIG. 10, analysis of the color through the captured image C1 may be expressed by a color table AI. The color table AI may reflect an overall atmosphere of the captured image C1, a color of a particular portion, and/or contrast.

The controller 180 may control the optical output unit 10 based on the color table AI of the captured image. For example, the controller 180 may control at least one of whether the optical output unit 10 is to emit light, an emitting position, and an emitting color.

By controlling at least one of whether the optical output unit 10 is to emit light, an emitting position, and an emitting color, user sensitivity quality of the mobile terminal 100 may be enhanced. For example, changing a color of the optical output unit 10 according to a color of the clothes of the user of the mobile terminal 100 may appeal to the user as a new sensitivity point.

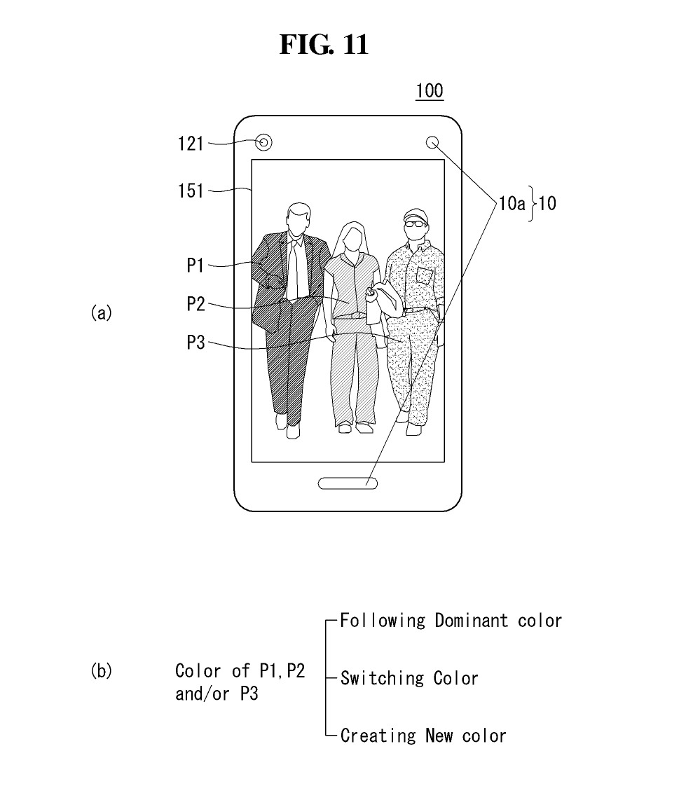

As illustrated in FIG. 11(a), different operations may be performed according to color information included in an image which has been captured or being captured.

An image may be captured by the camera 121 of the mobile terminal 100. The captured image may be displayed on the display unit 151. The image may include a plurality of objects. For example, the image may include first to third persons P1 to P3.

The first to third persons P1 to P3 may have different colors. For example, the first person P1 may be dressed in red, the second person P1 may be dressed in blue, and the third person P3 may be dressed in yellow.

The controller 180 may control the optical output unit 10 based on the colors of the first to third persons P1 to P3 as imaged objects.

As illustrated in FIG. 11(b), the controller 180 may control the optical output unit 10 based on the most dominant color among the colors of the first to third persons P1 to P3. For example, in a case in which the red color of the first person P1 occupies the largest area, the controller 180 may control the optical output unit 10 to emit red light.

The controller 180 may change a color of the optical output unit 10 such that it corresponds to the colors of the first to third persons P1 to P3. For example, the red color corresponding to the color of the first person P1, the blue color corresponding to the color of the second person P2, and the yellow color corresponding to the third person P3 may be sequentially emitted. Emitting order and/or emitting duration may be based on the importance of a corresponding color occupying the image.

The controller 180 may control the optical output unit 10 to emit light with a new color based on the colors of the first to third persons P1 to P3. For example, the controller 180 may control the optical output unit 10 to emit light with a color corresponding to a combination of the colors of the first to third persons P1 to P3.

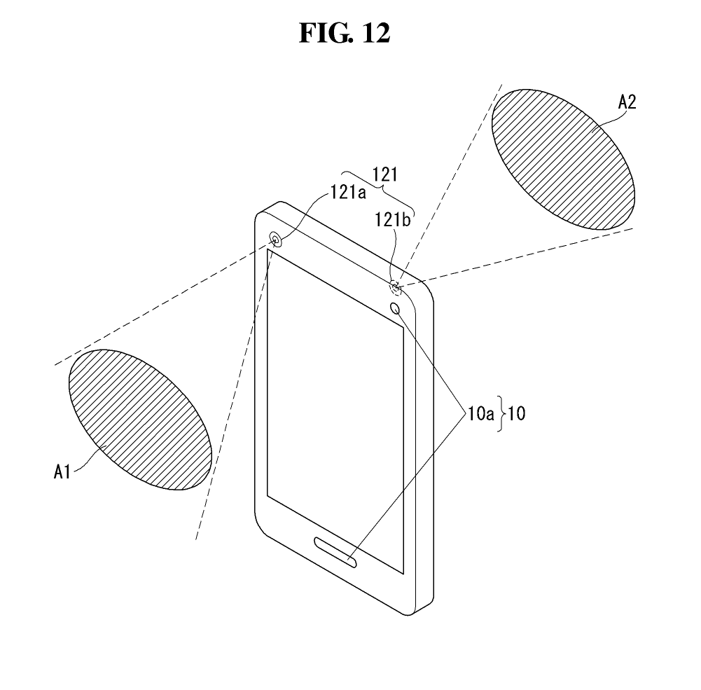

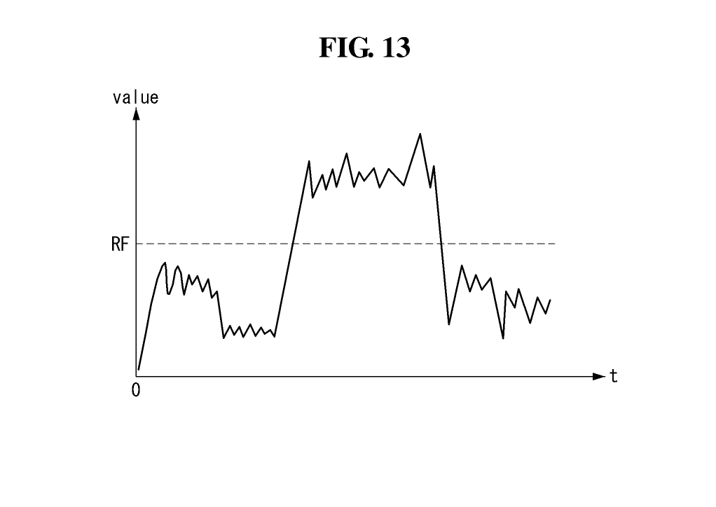

As illustrated in FIG. 12, the controller 180 may determine emitting of the optical output unit 10 based on colors of images captured by the plurality of cameras 121 installed in the mobile terminal 100. For example, the controller 180 may determine an operation of the optical output unit 10 based on information of a first area A1 imaged through the front camera 121a and information of a second area A2 imaged through the rear camera 121b. FIGS. 13 through 36 are views illustrating operations of the mobile terminal of FIG. 1 according to various embodiments.

As illustrated in these drawings, the controller 180 of the mobile terminal 100 according to an embodiment and may sense a surrounding situation in various manners.

As illustrated in FIG. 13, the controller 180 of the mobile terminal 100 may sense a surrounding environment by using the microphone 122. For example, the controller 180 may sense a user's voice and/or an ambient sound.

The sound sensed by using the microphone 122 may be variously changed. For example, in a case in which a call voice of the user is sensed, a low voice tone may be sensed at a particular point in time, while a high voice tone may be sensed at a different point in time. The controller 180 may determine the user's call voice based on a pre-set reference RF. The pre-set reference RF may be a measure for sensing a current user's feeling.

In a case in which a sound volume is equal to or greater than the pre-set reference RF, the controller 180 may reflect it through the optical output unit 10. For example, in a case in which the voice tone does not reach the pre-set reference RF, the optical output unit 10 may emit soft light, and when the voice tone exceeds the pre-set reference RF, the optical output unit 10 may emit strong light.

The controller 180 may analyze a user's voice itself. For example, the controller 180 may analyze a word, a tone, or the like, included in the user's voice. Upon analyzing the user's voice, the controller may reflect the results in a color of the optical output unit 10, or the like.

The controller 180 may change a color, or the like, by using a previously stored analysis table. For example, an analysis table including grouped words may exist. In a case in which a word included in a voice, or the like, corresponds to a specific group, the controller 180 may control the optical output unit 10 to operate in a color or pattern corresponding to the group. For example, in a case in which a negative word is included in a message and/or conversation, the optical output unit 10 may emit red light, and when a positive word is included therein, the optical output unit 10 may emit blue light. The color may be kept on until when a message is checked (or read) and/or the corresponding conversation continues. When the message is read and/or the conversion is terminated, the emitting of the optical output unit 10 may be terminated.

The controller 180 may change an emitting position and/or color of the optical output unit 10 according to a call state. For example, in a general call mode in which the user performs call communication with the mobile terminal held to his ear, the optical output unit 10 positioned in the rear side of the mobile terminal 100 may emit light. When the mobile terminal 100 is in a speaker phone mode, the optical output unit 10 positioned in the front side of the mobile terminal 100 may emit light. Namely, an emitting position of the optical output unit 10 may be changed according to a call mode as a specific event situation.

In a case in which the mobile terminal 100 is reversed, the controller 180 may control the optical output unit 10 positioned in the rear side of the mobile terminal 100 to emit light. Thus, even when a message is received in the reversed state of the mobile terminal 100, the user may easily recognize the reception of the message visually.

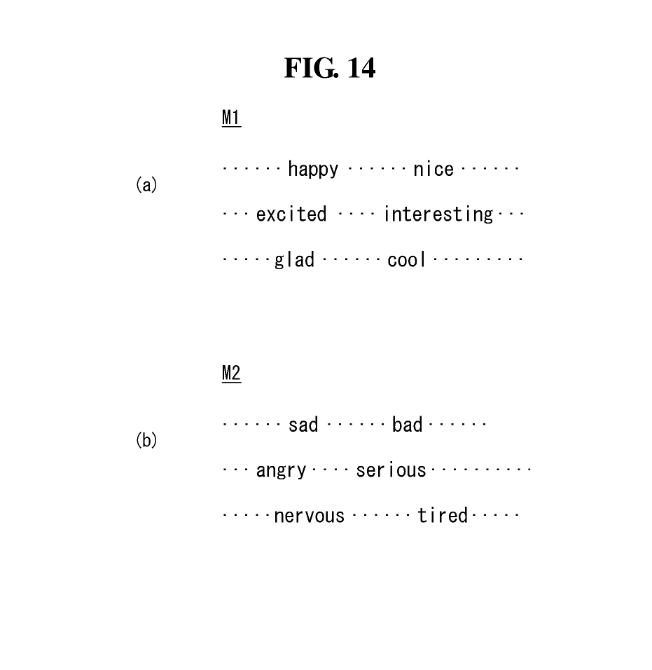

As illustrated in FIG. 14, the controller 180 may change a color, or the like, of the optical output unit 10 based on an analysis of a sentence that the user transmits or receives or that the user is viewing.

As illustrated in FIGS. 14(a) and 14(b), the user may transmit and receive a first text message M1 or a second text message M2. The first text message M1 may include overall positive words, and the second text message M2 may include overall negative words.

The controller 180 may change a color of the optical output unit 10 according to types of the first and second text messages M1 and M2. For example, the controller 180 may operate the optical output unit 10 differently when the first text message M1 including positive words is transmitted or received and when the second text message M2 including negative words is transmitted or received.

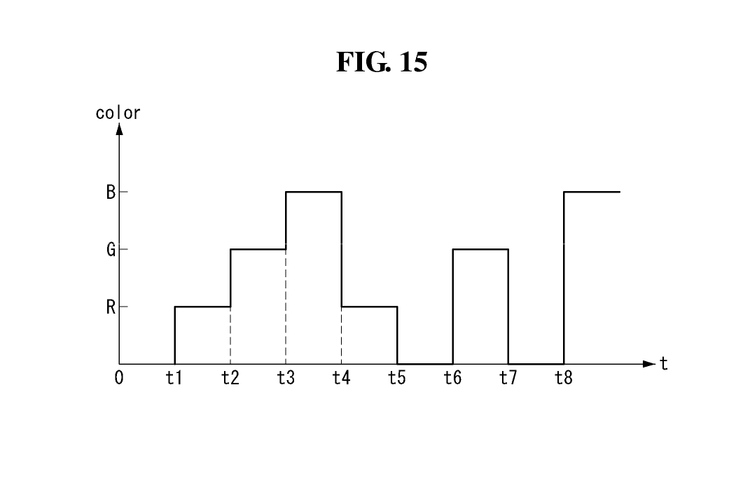

As illustrated in FIG. 15, a color of the optical output unit 10 may change over time. Namely, when a specific event occurs, a color may be changed to correspond thereto. For example, in a case in which a positive word is included, the optical output unit 10 may emit blue light, and in a case in which a negative word is included, the optical output unit 10 may emit red light. Also, a emitting duration and/or emitting period may vary according to positive and/or negative strength. As mentioned above, a color may reflect the mobile terminal 100 user's feeling and/or sender's feeling.

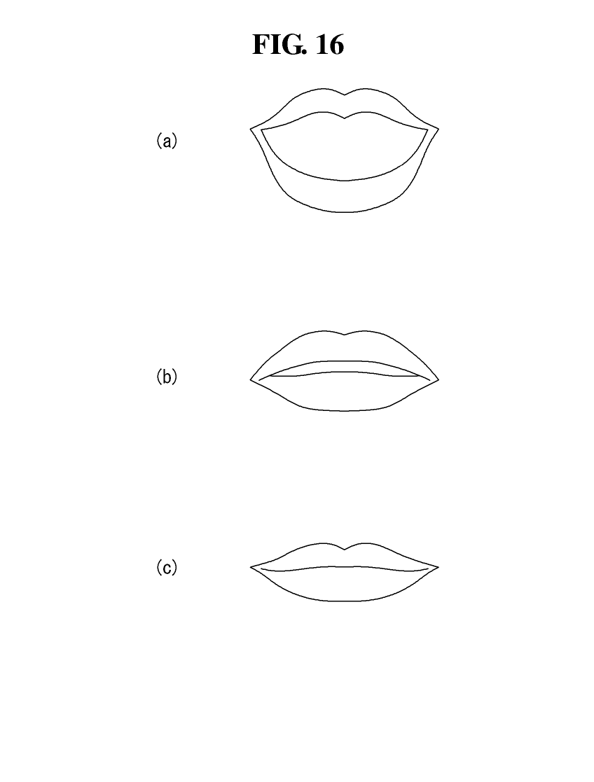

As illustrated in FIG. 16, the controller 180 may operate the optical output unit 10 differently based on feeling information of a person included in an image captured by the camera 121. Also, the controller 180 may control an operation of the optical output unit 10 based on feeling information even while image capturing is being performed.

The controller 180 may determine a user's feeling based on a shape of a mouth of a person included in the image captured by the camera 121. As illustrated in FIGS. 16(a) to 16(c), the shapes of the imaged mouth of the person may vary. For example, the shapes of the imaged mouth of the person may include a shape of smiling mouth, a shape of an angry mouth, and a shape of a mouth with compressed lips. Each of the shapes of the mouth may be considered to reflect a user's emotional condition at the time. Upon determining the user's emotion based on the image of the mouth included in the captured image, the controller 180 may operate the optical output unit 10 differently. The user's emotion may also be sensed through a shape of the eyes of the person included in the captured image, or the like.

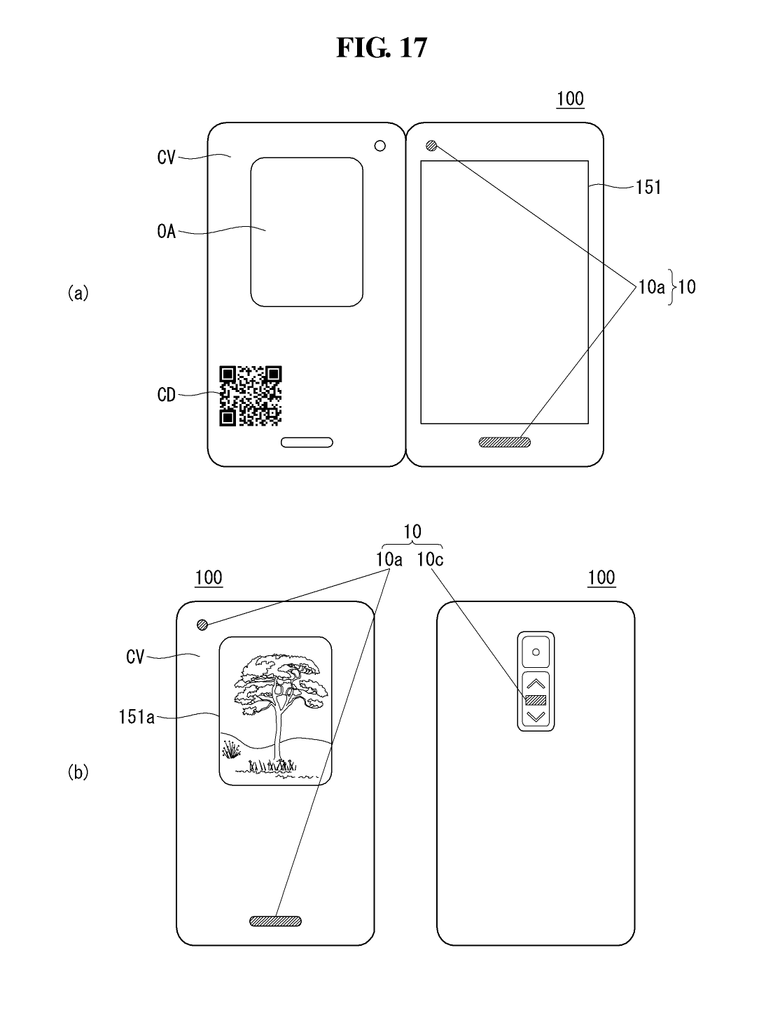

As illustrated in FIG. 17, the controller 180 may change a color of the optical output unit 10 based on a color, a type, or the like, of a cover CV f the mobile terminal 100.

As illustrated in FIG. 17(a), the cover CV may be configured to cover at least a portion of the front side of the mobile terminal 100. An opening OA may be provided in a region of the cover CV to allow a partial region of the display 151 to be observed even with the cover CV closed.

Cover information CD may be positioned in a region of the cover CV. The cover information CD may be a code that may be sensed by the camera 121, or the like. The cover information CD may be positioned at an inner side of the cover CV. Thus, in a case in which the cover CV is closed, the controller 180 may sense content thereof.

The cover information CD provided in the cover CV may be sensed through the display 151. Namely, in a case in which the display 151 is configured to serve to display an image and sense an external image, when the cover CV is closed, information may be scanned as the cover information CD is tightly attached to the display 151.

When the information of the cover information CD is scanned, the controller 10 may change a color, or the like, of the optical output unit 10 such that it corresponds thereto. For example, the controller 180 may change a color, or the like, of the optical output unit 10 based on a color, material, or the like, of the cover CV.

As illustrated in FIG. 17(b), even when the cover CV is tightly attached to the mobile terminal 100, a partial display region 151a of the mobile terminal 100 may be observed through the opening OA. Also, the first optical output unit 10a may be observed through at least one through hole provided in the cover CV. In addition, the third optical output unit 10c may be observed through a different through hole of the cover CV in the rear side of the mobile terminal 100.

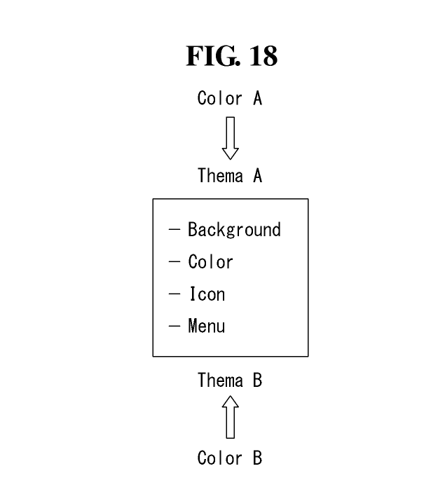

As illustrated in FIG. 18, the controller 180 may change a theme of the mobile terminal 100 according to a color of the cover CV, or the like. The theme may include a form of a background, a type of color, a type of icon, a menu form, of the display 151, and the like. Namely, themes A and B may have different atmospheres such as backgrounds, or the like.

Based on the information obtained from the cover CV, the controller 180 may change a theme. For example, in a case in which a color of the cover CV is A, the controller 180 may change a current theme to a theme A, and when a color of the cover CV is B, the controller 180 may change a current theme to a theme B. Thus, when only the cover CV is changed, the theme may also be naturally changed without user inconvenience of changing the theme separately.

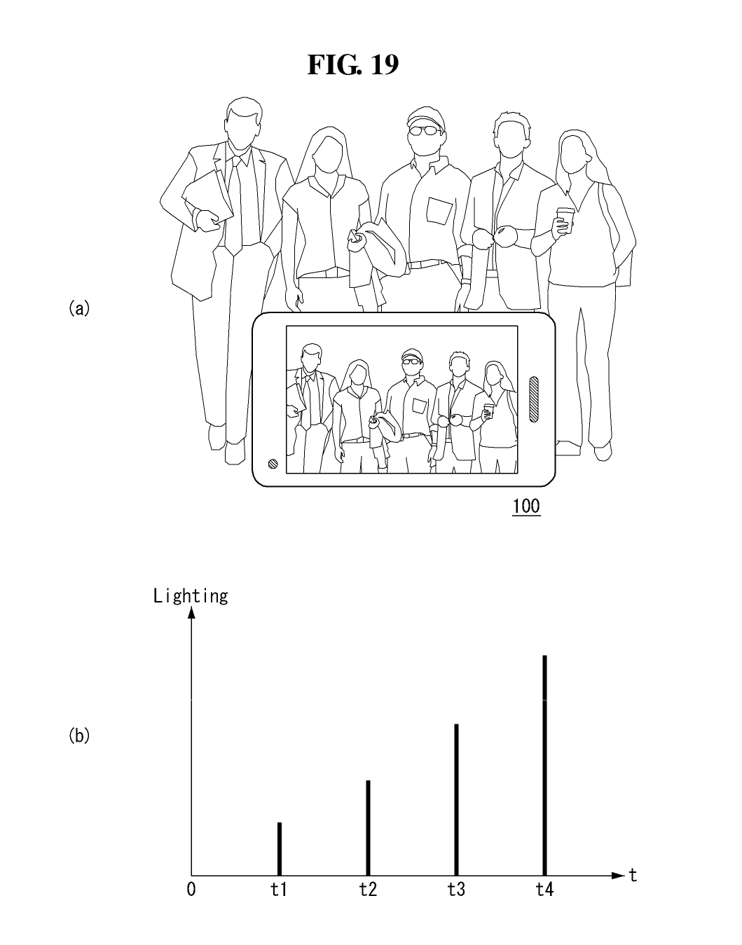

As illustrated in FIG. 19, the controller 180 of the mobile terminal 100 may inform the user about a progressive state of portrait image capturing through the optical output unit 10.

As illustrated in FIG. 19(a), image capturing may be performed using the mobile terminal 100. An image capture mode may include a timer mode. Namely, when image capturing starts, image capturing may be performed actually after the lapse of a predetermined time.

As illustrated in FIG. 19(b), image capturing may be performed at a point in time t4. The controller 180 may control the optical output unit 10 to emit light at predetermined intervals up to the point in time t4. Here, in consideration of a direction in which image capturing is performed, the controller 180 may operate the optical output unit 10 corresponding to the direction. For example, in the case of FIG. 19(a), the optical output unit 10 positioned in the rear side of the mobile terminal 100 may emit light.

The controller 180 may control the optical output unit 10 to emit different colors and/or emit different intensity of light. For example, the optical output unit 10 may emit light color at a point in time t1, first light emission, and with the lapse of time, the optical output unit 10 may emit gradually stronger light. At the final point in time t4, the optical output unit 10 may emit light with an appropriate amount required for capturing an image and/or emit light with appropriate intensity. Information regarding a point in time at which image capturing is to be performed may be provided to a subject to be imaged, through the optical output unit 10, to allow the subject to be imaged to be ready for image capturing. Also, the optical output unit 10 providing information regarding a point in time at which image capturing is to be performed finally may also serve as a flash by itself.

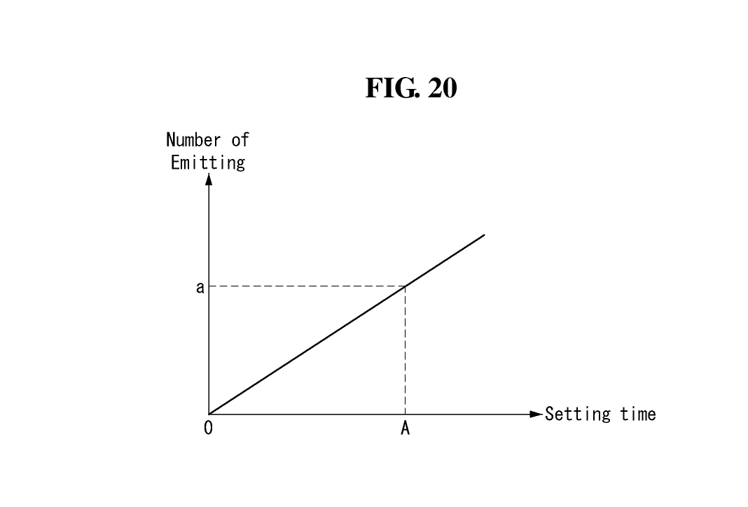

As illustrated in FIG. 20, a number of times of emitting the optical output unit 10 may vary according to a pre-set setting. For example, the user of the mobile terminal 100 may set how many times the optical output unit 10 is to emit light in a specific event. Also, the user may set an emitting position, an emitting color, and the like.

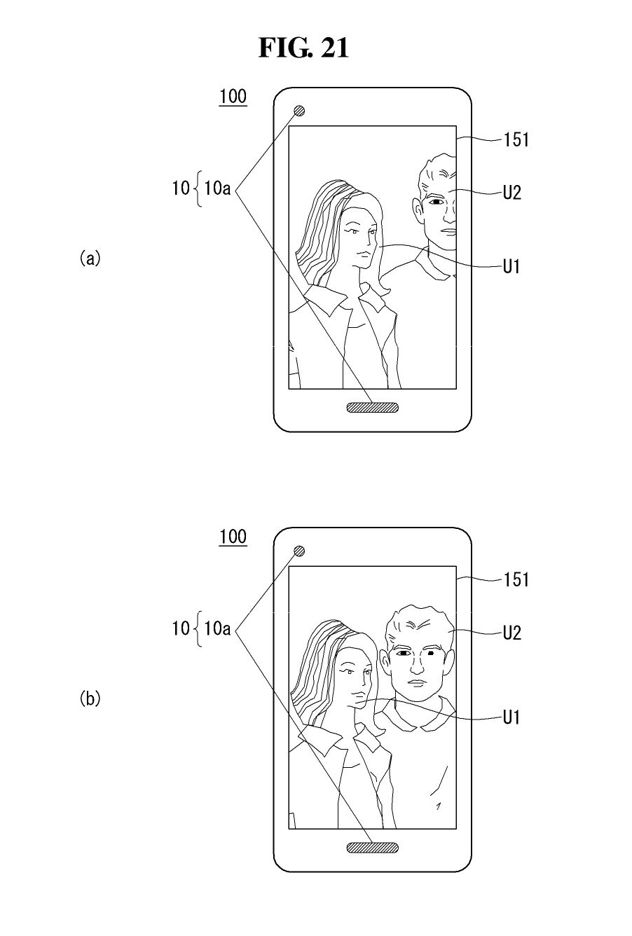

As illustrated in FIG. 21, the controller 180 of the mobile terminal 100 may provide information regarding the number of persons being imaged through the optical output unit 10.

As illustrated in FIG. 21(a), a plurality of persons may be imaged by using the mobile terminal 100. For example, image capturing may be performed on first and second persons U1 and U2. The first person U1 may be positioned within an image capture range of the camera 121, while the second person U1 is out of the image capture range of the camera 121. Namely, in a current state, the second person U2 may not be properly imaged.

The controller 180 may inform the user about the number of persons on which image capturing may be properly performed, through the optical output unit 10. For example, the controller 180 may provide information regarding the number of persons currently being imaged through the number of times of emitting the optical output unit 10 positioned in the rear side of the mobile terminal 100. In a situation of FIG. 21(a), the controller 180 may provide information that one person is normally imaged by controlling the optical output unit 10 to emit light once. Thus, without user inconvenience that image capturing is performed again after captured images are checked, desired images may be captured.

As illustrated in FIG. 21(b), the first and second persons U1 and U2 may be positioned within the normal image capture range. In this situation, the controller 180 may control the optical output unit 10 to emit light twice to provide information that two persons are normally imaged currently.

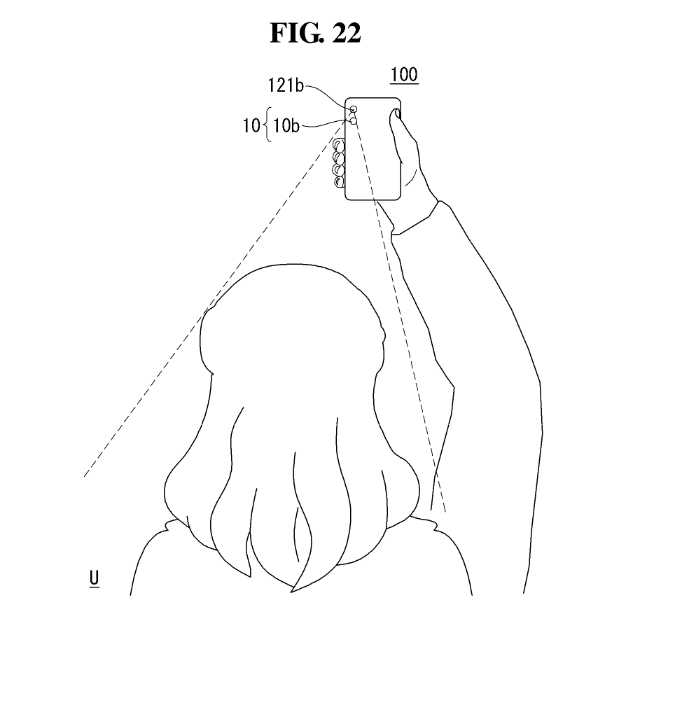

As illustrated in FIG. 22, the user U may capture an image by using the mobile terminal 100. Here, the user may capture an image of herself by using the rear camera 121b in the rear side of the mobile terminal 100. In this case, the user herself who is capturing her image cannot check whether she is normally being imaged. Namely, since the display 151 is positioned in the opposite direction, the user U cannot check whether image capturing has been properly performed until image capturing is finished. The mobile terminal 100 according to an embodiment may transmit an imaging state to the user U in real time through the optical output unit 10.

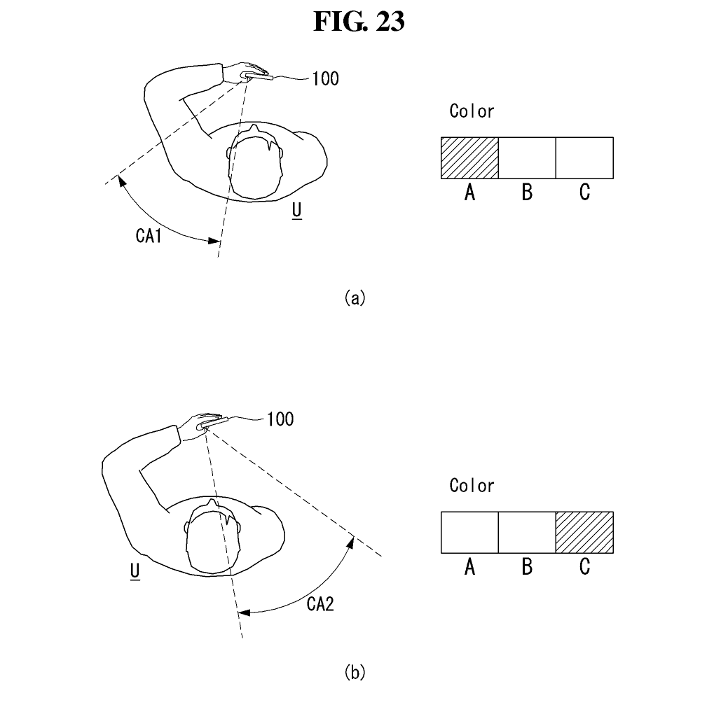

As illustrated in FIG. 23(a), the user U who is capturing an image by using the rear camera 121b may fail to manipulate the mobile terminal 100 to capture an image of a first image capture region CA1. The first image capture region CA1 may be a left portion of the user U. Namely, the user U may not be accurately imaged. In this situation, the controller 180 may control the optical output unit 10. Namely, the controller 180 may analyze the captured image, and in this case, when the user U has not been properly imaged, the controller 180 may control the optical output unit 10 to operate in the color A. Alternatively, the optical output unit 10 may emit light with a specific color in a specific pattern to provide information that the first image capture region CA1 based on the user U is being imaged.

As illustrated in FIG. 23(b), the user U, who is capturing an image by using the rear camera 121b, may capture an image of a second image capture region CA2. In the case in which the second image capture region CA2 is being imaged, the controller 180 may control the optical output unit 10 to operate in a manner different from that of capturing the first image capture region CA1. For example, the controller 180 may control the optical output unit 10 to emit light with a color C. The optical output unit 10 may emit light with the color C at a specific period and/or brightness. Thus, the user may recognize a currently imaged region by intuition.

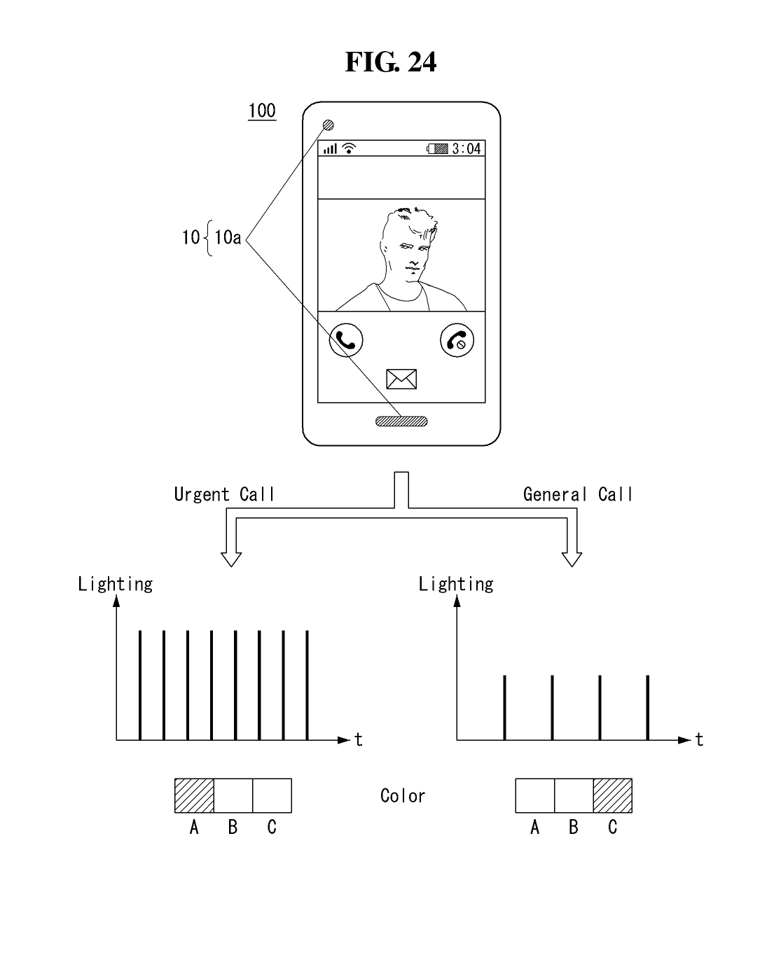

As illustrated in FIG. 24, the controller 180 may differentiate an output of the optical output unit 10 according to a type of received call. For example, according to a sender of a received call, the controller 180 may change whether the optical output unit 10 is to emit light, an emitting degree, an emitting color, and the like.

Based on information of the sender of the received call, the controller 180 may recognize importance of the received call. In a case in which importance of the received call is high, the controller 180 may operate the optical output unit 10 with stronger color, intensity, and the like. In a case in which importance of the received call is low, the controller 180 may operate the optical output unit 10 with smooth color, intensity, and the like.

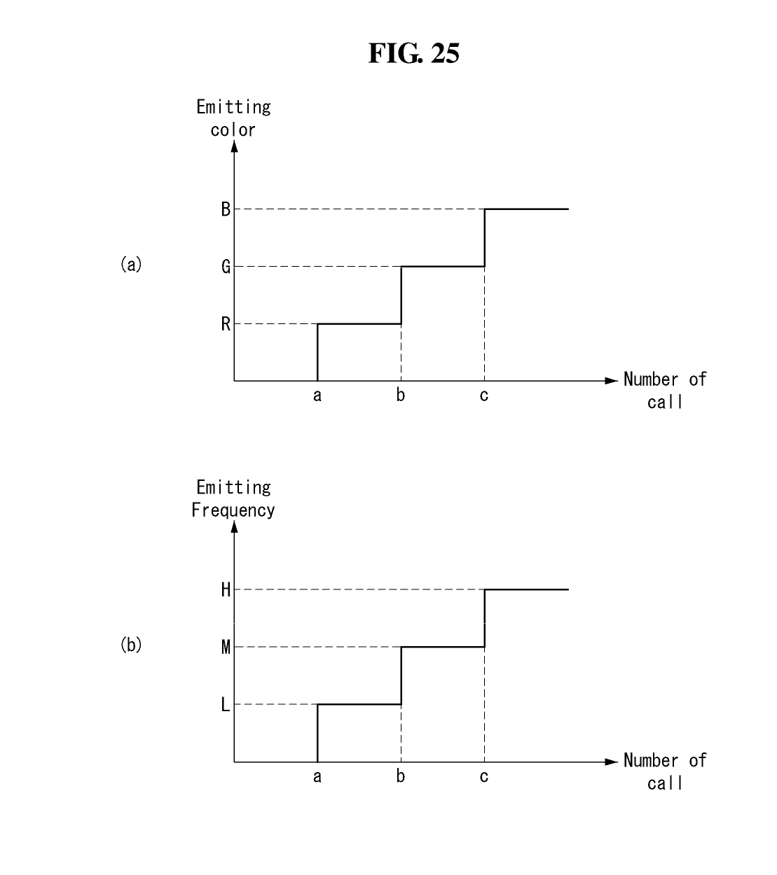

As illustrated in FIG. 25, the controller 180 may operate the optical output unit 10 differently according to the received call and/or the number of times of message.

As illustrated in FIGS. 25(a) and 25(b), when the number of received calls is changed, the color and/or emitting frequency generated by the optical output unit 10 may vary. Namely, the color of the optical output unit 10 may be changed according to the number of calls and/or messages received from the same counterpart. For example, when a first call is received, the optical output unit 10 may emit blue light, and the color of the optical output unit 10 may be changed to green and red color according to the number of calls. Here, the number of calls may be a number of absent calls, a number of calls with a corresponding counterpart, and the like. The user of the mobile terminal 100 may estimate who is a counterpart upon simply viewing a color and/or light emission pattern of the optical output unit 10, without having to check a name and/or a phone number of the counterpart on the display unit 151.

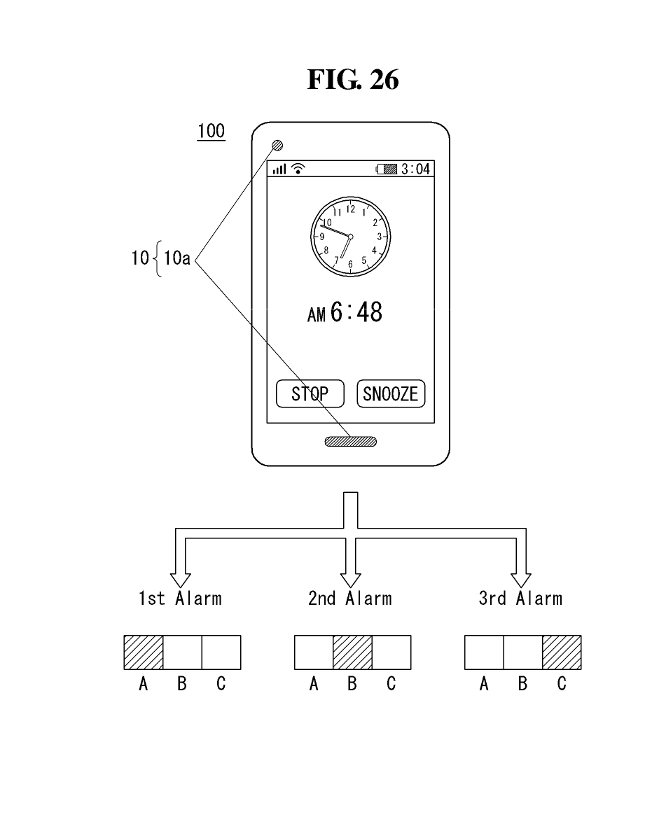

As illustrated in FIG. 26, the controller 180 may differentiate an output of the optical output unit 10 according to the number of times of alarming. The controller 180 may differentiate a color, intensity, and the like, of the optical output unit 10 according to the number of times of selecting snooze by the user. For example, in the event of first alarming, the controller 180 may control the optical output unit 10 to emit light with color A. In the event of second alarming, the controller 180 may control the optical output unit 10 to emit light with color B. In the event of third alarming, the controller 180 may control the optical output unit 10 to emit light with color C.

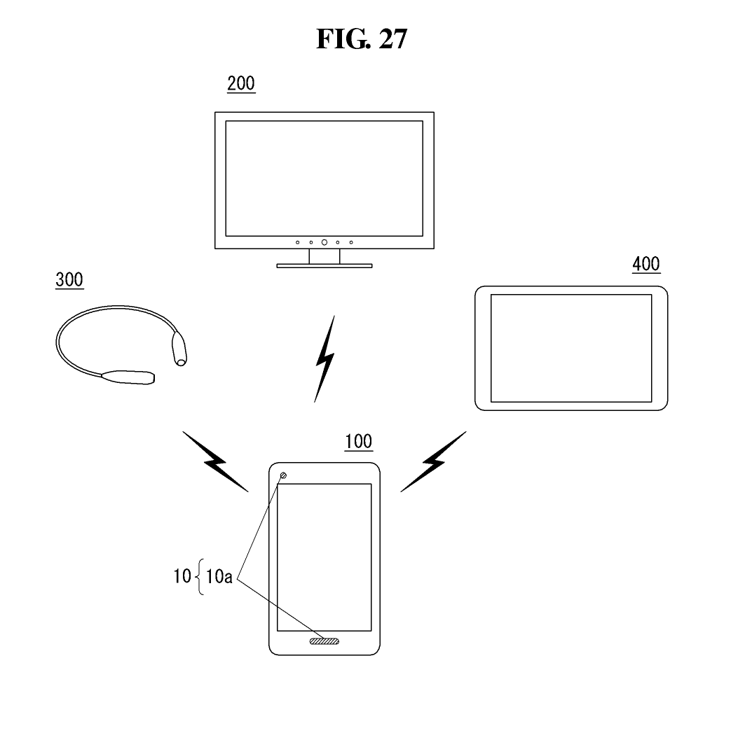

As illustrated in FIG. 27, the mobile terminal 100 may communicate with at least one different device 200, 300, or 400. The controller 180 may allow the user to recognize whether communication is performed with a different device, or the like, by intuition through an operation of the optical output unit 10. For example, when the mobile terminal 100 is paired with the first device 200, the controller 180 may control the optical output unit 10 to operate. Even when the mobile terminal 100 is paired with the second and third devices 300 and 400, the controller 180 may control the optical output unit 10 to operate. Also, when a connection with a different device is terminated, the controller 180 may control the optical output unit 10 operate. For example, the optical output unit 10 may operate in a color and/or pattern different from that of the case in which a connection of the mobile terminal 100 to a different device is initiated and/or the mobile terminal 100 is currently connected to a different device.

In the case in which the mobile terminal is pared with the first to third devices 200 to 400, the controller 180 may operate the optical output unit 10 in different colors and intensity. When an operation of the optical output unit 10 is changed according to a point in time at which the mobile terminal 100 is paired and/or a target to which the mobile terminal 100 is paired, the user may recognize the paring and/or the target by intuition.

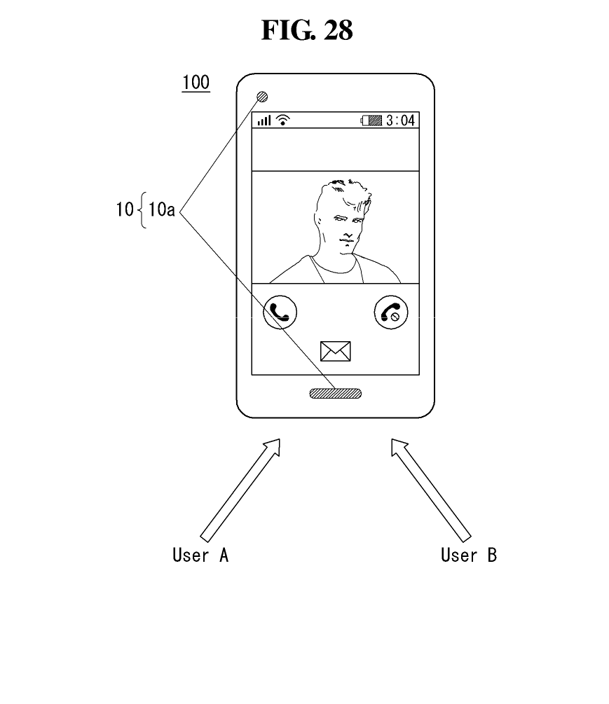

As illustrated in FIG. 28, the mobile terminal 100 may be used by a plurality of users. For example, a plurality of user may use the specific mobile terminal 100 by changing a USIM card. The controller 180 may control the optical output unit 10 to operate differently in a case in which a user A uses the mobile terminal 100 and in a case in which a user B uses the mobile terminal 100. For example, in a case in which a USIM card of the user A is inserted, the controller 180 may control the optical output unit 10 to emit yellow light, and in a case in which a USIM card of the user B is inserted, the controller 180 may control the optical output unit 10 to emit red light.

When power is applied to the mobile terminal 100, the controller 180 may provide information regarding how many USIM cards are allowed to be used, by a color and/or pattern of the optical output unit 10. For example, when there is history that two USIM cards have been used in the corresponding mobile terminal 100, the controller 180 may control the optical output unit 10 to emit yellow and red light alternately to allow the user to be informed by intuition.

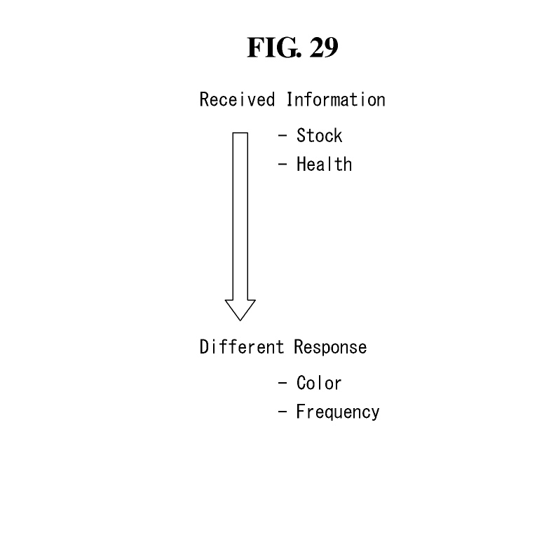

As illustrated in FIG. 29, the controller 180 may control the optical output unit 10 to operate in different manners according to obtained information. For example, the controller 180 may obtain stock information and/or health information through the wireless communication unit 110. Health information may be biometric information of the user of the mobile terminal 100. For example, health information may include information regarding pulsation, a body temperature, and the like, obtained through a device such as a watch, or the like, the user is wearing. Since an operational color of the optical output unit 10 is changed upon receiving the obtained information, the user may recognize the corresponding information by intuition, without having to check data through a related application.

The controller 180 may change an operational color of the optical output unit 10 based on obtained stock information. For example, in a case in which a stock price index, or the like, rises, the controller 180 may control the optical output unit 10 to emit red light, and in a case in which a stock price index, or the like, falls, the controller 180 may control the optical output unit 10 to emit blue light.

The controller 180 may change an operational color, or the like, of the optical output unit 10 based on obtained biometric information. For example, in a case in which an amount of activity is large, the controller 180 may control the optical output unit 10 to emit red light, and in a case in which an amount of activity is small, the controller 180 may control the optical output unit 10 to emit blue light.

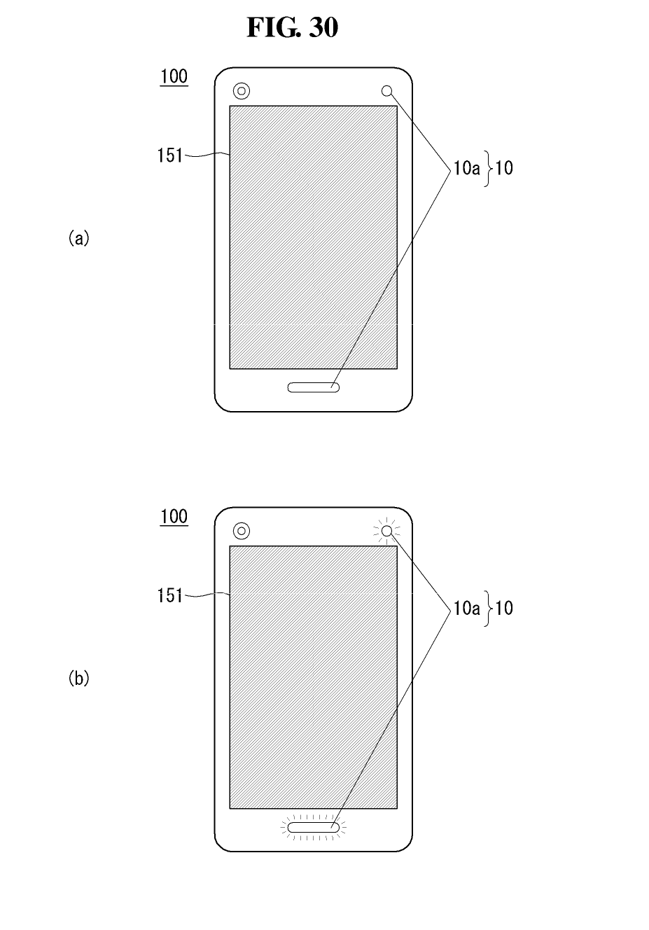

As illustrated in FIG. 30, the controller 180 may inform the user about an occurrence of a specific event by using the optical output unit 10 regardless of whether the display 151 has been activated.

As illustrated in FIG. 30(a), the display unit 151 may be in a state of dimming or in a turned-off state.

As illustrated in FIG. 30(b), although information is not displayed on the display unit 151, when a specific event occurs, the controller 180 may control the optical output unit 10 to operate. For example, in a case in which obtained stock information, weather information, and health information reaches a specific point previously set by the user and/or the controller 180, the controller 180 may control the optical output unit 10 to emit light with a specific color and/or pattern. Thus, the user may recognize the occurrence of the specific event by intuition without having to check it through the display 151.

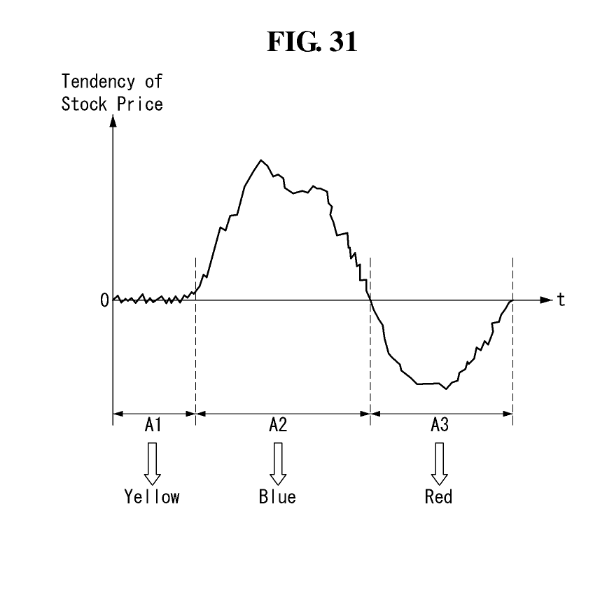

As illustrated in FIG. 31, a specific event may be a tendency of stock. For example, there may be no particular tendency in stock during a period A1, stock may rise during a period A2, and stock may fall during a period A3. The controller 180 may control the optical output unit 10 to emit light with different colors during the periods A1, A2, and A3 based on obtained information. Thus, the user may immediately recognize the occurrence of a specific event by intuition based on the color and/or pattern of the optical output unit 10 without having to drive a stock-related application or view the display 151. The user may set a specific item, a specific condition under which the optical output unit 10 is to operate, and/or a specific time at which the optical output unit 10 is to operate, in advance. When the user manipulates the mobile terminal 100 at a point in time at which an occurrence of a specific event is informed by the optical output unit 10, the controller 180 may specifically display corresponding information.

The specific event may include weather, biometric information of the user, e-mail reception, and the like. For example, when specific weather information set by the controller 180 and/or the user is received, the controller 180 may provide the corresponding information through the optical output unit 10. For example, the optical output unit 10 may provide weather information in a color and/or pattern at a specific point in time every morning. Thus, the user may recognize weather by intuition based on a state of the optical output unit 10 without having to perform manipulation.

The controller 180 may provide user's biometric information through a color and/or pattern of the optical output unit 10. For example, the controller 180 may provide information regarding a current condition of the user based on information regarding a user's body temperature, pulsation, and the like, obtained through a sensor attached to the user's body. In this manner, the user may check an amount of activity, an amount of workout, a health condition, and the like, of his or her own by intuition.

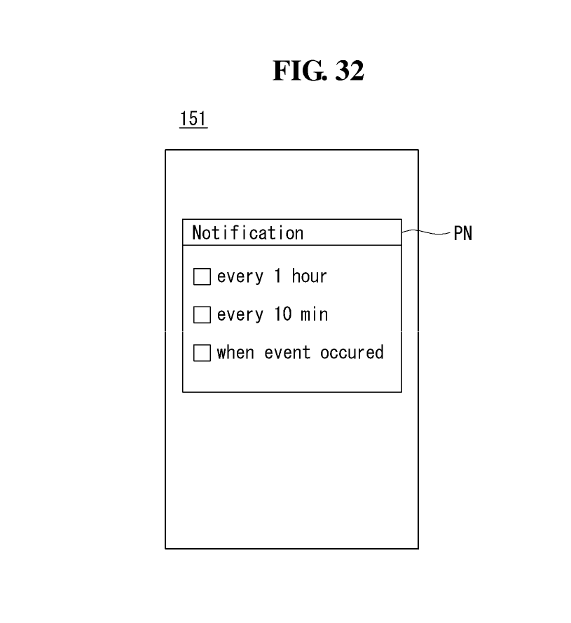

The controller 180 may provide e-mail reception information through the optical output unit 10. For example, in a case in which a new e-mail is received, the controller 180 may provide corresponding information through the optical output unit 10. In this case, as mentioned above, when the mobile terminal 100 is manipulated while the optical output unit 10 is being operated, an application for reading the e-mail may be immediately driven. As illustrated in FIG. 32, the optical output unit 10 may operate according to pre-set conditions. The controller 180 may provide a condition input window PN. Conditions for the optical output unit 10 to operate may include a predetermined time interval and/or occurrence of a specific event, and the like.

The controller 180 may allow the user to recognize a stock price index of a specific stock at predetermined time intervals through the optical output unit 10. For example, the user may recognize a rise in a stock price, the balance of stock, and a fall in a stock price at predetermined time intervals, respectively, through the red, yellow, and blue optical output unit 10.

The controller 180 may control the optical output unit 10 to flicker in a particular condition. For example, when a specific event such as a sharp rise, a sharp fall, and the like, occurs, the optical output unit 10 may flicker at a corresponding speed. Thus, the user may immediately recognize a current situation without having to manipulate the mobile terminal 100.

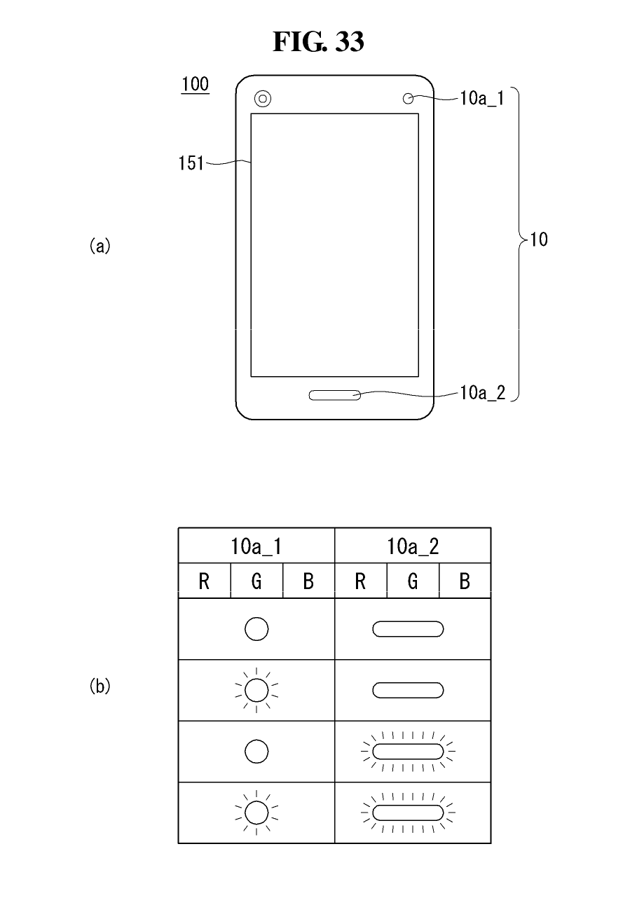

As illustrated in FIG. 33, the controller 180 may control the optical output unit 10 differently to allow the user to immediately recognize a current situation.

As illustrated in FIG. 33(a), the front optical output unit 10 may be divided into a first front optical output unit 10a_1 and a second optical output unit 10a2. The controller 180 may control the first and second optical output unit 10a_1 and 10a_{—}2 differently according to specific conditions.

As illustrated in 33(b), the first and second optical output unit 10a_1 and 10a_2 may express R, G, and B colors, respectively. Each of the colors may correspond to a state of a specific event. For example, a rise in a stock price, the balance, and a fall in a stock prices may correspond to R, G, and B, respectively.

The first and second optical output unit 10a_1 and 10a_2 may correspond to a specific person, respectively. The first optical output unit 10a_1 may flicker when an event corresponding to Jane occurs, and the second optical output unit 10a_2 may flicker when an event corresponding to Tom occurs. For example, the colors R, G, and B may be sequentially changed according to the number of times of reception of messages from Jane.

The controller 180 may control the first and second optical output unit 10a_1 and 10a_2 to flicker selectively. An event occurrence state may be displayed through a combination of the first and second optical output unit 10a_1 and 10a2. For example, in a case in which a stock price index is in an uptrend, only the first optical output unit 10a_1 may emit light, and in a case in which the stock price index enters a sharp rise, both the first and second optical output unit 10a_1 and 10a_2 may emit light together.

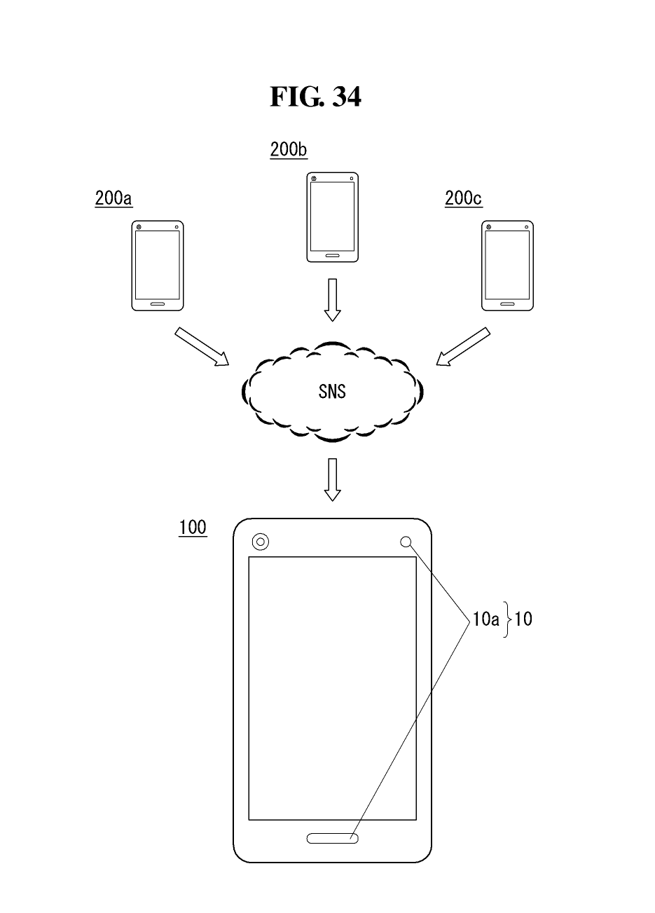

As illustrated in FIG. 34, the mobile terminal 100 may receive a message from a different terminal 200a to 200c. For example, the mobile terminal 100 may receive a message through an SNS, or the like. The controller 180 may control an operation of the optical output unit 10 based on a type, a sender, or the like, of the received message.

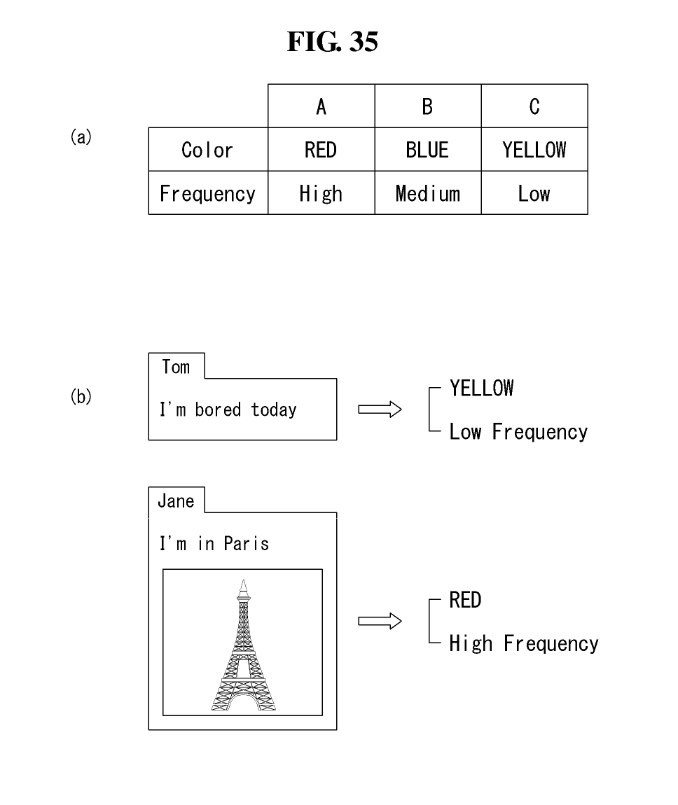

As illustrated in FIG. 35(a), it is assumed that there are senders A, B, and C. The controller 180 may operate the optical output unit 10 differently according to a sender. For example, a color of the optical output unit 10 may vary according to a sender through setting by the user in advance or according to a controlling operation of the controller 180. Thus, the user of the mobile terminal 100 may recognize a counterpart by intuition upon simply viewing a color of the optical output unit 10.

The controller 180 may differentiate a light emission period for each sender. For example, in a case in which A is a counterpart set to be important by the user and/or a person with which the user keeps in touch frequently, the controller 180 may shorten a light emission period of the optical output unit 10 when a message is received from A. Alternatively, in a case in which messages received from A have been accumulated, or the like, the controller 180 may change the light emission period proportionally.

As illustrated in FIG. 35(b), the controller 180 may differentiate a light emission form according to an attribute of a message. For example, the controller 180 may control the optical output unit 10 to emit differently in a case in which a received message includes only text and in a case in which a received message includes an image. Namely, in the case in which the received message includes only text, the controller 180 may control the optical output unit 10 to emit yellow light and/or at a low period, while in the case in which a received message includes an image, the controller 180 may control the optical output unit 10 to emit red light and/or at a high period, to allow the user to recognize it.

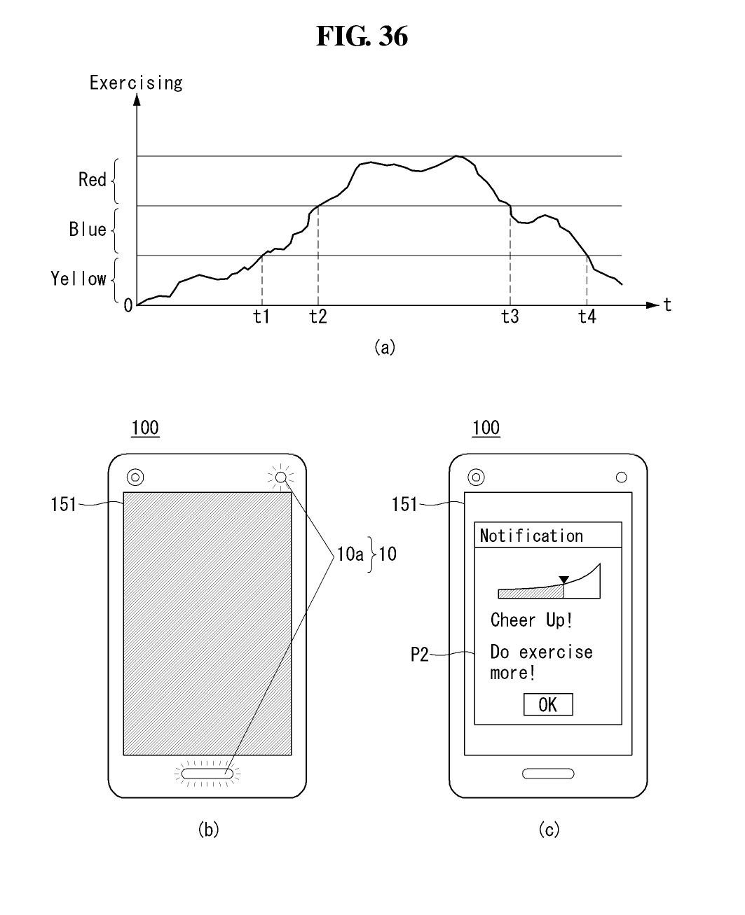

As illustrated in FIG. 36, the controller 180 may display user's exercise information by the optical output unit 10.

As illustrated in FIG. 36(a), an amount of exercise of the user may vary over time. The amount of exercise of the user may be sensed by an accelerometer, a position sensor, and the like, installed in the mobile terminal 100. For example, a speed of the user may be sensed based on a change in acceleration, a change in a position, and the like, based on which an amount of exercise of the user may be calculated.

The amount of exercise of the user may be displayed in a pre-set manner through the optical output unit 10. For example, an amount of exercise of the user may be displayed in yellow, blue, and red according to a degree of the exercise. The optical output unit 10 may be continuously displayed in a section corresponding to a pre-set range of an amount of exercise. The optical output unit 10 may be displayed at a point in time at which an amount of exercise is changed. For example, the optical output unit 10 may be displayed before or after a point in time at which a threshold value of an amount of exercise is changed, like t1, t2, t3, and t4.

As illustrated in FIG. 36(b), the controller 180 may display a current state of an amount of exercise through the optical output unit 10. The controller 180 may display a comparison between a recommended amount of exercise and a current amount of exercise. For example, in a case in which a recommended amount of exercise of the user is 100, if a current amount of exercise does not reach the recommended amount of exercise, the optical output unit 10 may be displayed in yellow, and when a current amount of exercise exceeds 100, the optical output unit 10 may be displayed in blue.

As illustrated in FIG. 36(c), the controller 180 may display an exercise condition of the user as a pop-up window P2 on the display 151. An amount of exercise of the user, such as a graph of a current amount of exercise in comparison with a target amount of exercise, or the like, may be specifically displayed in the pop-up window P2.

The pop-up window P2 may be displayed according to an additional operation of the user. Namely, in a state in which information is displayed by the optical output unit 10, when the user presses a button of the mobile terminal 100 or touches the mobile terminal 100, the display 151 may be turned on and exercise information may be displayed. Thus, the user may immediately obtain required information without having to perform an additional operation such as executing a specific application, or the like.

The above-described method of controlling the mobile terminal may be written as computer programs and may be implemented in digital microprocessors that execute the programs using a computer readable recording medium. The method of controlling the mobile terminal may be executed through software. The software may include code segments that perform required tasks. Programs or code segments may also be stored in a processor readable medium or may be transmitted according to a computer data signal combined with a carrier through a transmission medium or communication network.

The computer readable recording medium may be any data storage device that can store data that can be thereafter read by a computer system. Examples of the computer readable recording medium may include read-only memory (ROM), random-access memory (RAM), CD-ROMs, DVD±ROM, DVD-RAM, magnetic tapes, floppy disks, optical data storage devices. The computer readable recording medium may also be distributed over network coupled computer systems so that the computer readable code is stored and executed in a distribution fashion.

A mobile terminal may include a first touch screen configured to display a first object, a second touch screen configured to display a second object, and a controller configured to receive a first touch input applied to the first object and to link the first object to a function corresponding to the second object when receiving a second touch input applied to the second object while the first touch input is maintained.

A method may be provided of controlling a mobile terminal that includes displaying a first object on the first touch screen, displaying a second object on the second touch screen, receiving a first touch input applied to the first object, and linking the first object to a function corresponding to the second object when a second touch input applied to the second object is received while the first touch input is maintained.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A mobile terminal comprising:
a case including a front side and a rear side;
at least one optical output unit configured to emit light, the at least one optical output unit positioned in at least one of the front side and the rear side of the case; and
a controller configured to obtain information and to control at least one of the light emission, the light emission color, the light emission duration and the light emission pattern of the at least one optical output unit based on the obtained information.

2. The mobile terminal of claim 1 further comprising at least one camera positioned in at least one of the front side and rear side of the case, wherein the obtained information is an image captured by the at least one camera, and wherein the controller is further configured to control the at least one optical output unit by changing at least one of the light emission and the light emission color based on the captured image.

3. The mobile terminal of claim 2, wherein the controller is further configured to control the at least one optical output unit based on color information associated with a person in the captured image.

4. The mobile terminal of claim 3, wherein the color information is based on the color of the person's clothing.

5. The mobile terminal of claim 3, wherein the controller is further configured to control the optical output unit by changing the light emission color to another color within the same series as the color according to the color information.

6. The mobile terminal of claim 2 further comprising:
a first camera positioned in the front side of the case and a second camera positioned in the rear side of the case; and
a first optical output unit positioned in the front side of the case and a second optical output unit positioned in the rear side of the case,
wherein the controller is further configured to control the light emission color of the first optical output unit based on first color information associated with a first image captured by the first camera, and to control the light emission color of the second optical output unit based on second color information associated with a second image captured by the second camera.

7. The mobile terminal of claim 2, wherein the controller is further configured to control the at least one optical output unit based on at least one of the appearance of a person in the captured image, a message transmitted and received by the mobile terminal, a person's voice, and a cover at least partially covering the case.

8. The mobile terminal of claim 1, wherein the received information is at least one of a received call, a received message, and a received e-mail, and wherein the controller is further configured to control the optical output unit based on at least one of the number of and the frequency of received calls, received messages, and received e-mails.

9. The mobile terminal of claim 1, further comprising:
a display positioned in the case, wherein the controller is further configured to control the optical output unit to emit light when the obtained information satisfies a specific condition, regardless of the display-operation.

10. The mobile terminal of claim 1 further comprising:
a display positioned in at least one surface of the case, wherein the controller is further configured to display the obtained information on the display when a user manipulation of the mobile terminal is sensed and the optical output unit is operating.

11. The mobile terminal of claim 1, wherein the obtained information is at least one of stock information, weather information and information concerning the health of a user of the mobile terminal.

12. The mobile terminal of claim 1, wherein the obtained information is a set amount of time, and wherein the controller is further configured to control light emission duration based on the set amount of time.

13. The mobile terminal of claim 1, wherein the controller is further configured to control light emission color in that the at least one optical output unit emits a different one of plurality of colors based on the obtained information.

14. The mobile terminal of claim 13, wherein the obtained information relates to the occurrence of a specific event.

15. A method for controlling a mobile terminal, the method comprising:
obtaining information; and
controlling the operation of at least one optical output unit positioned in a case of the mobile terminal based on the obtained information,
wherein controlling the operation of the at least one optical output unit comprises controlling at least one of light emission, light emission color, light emission duration, and light emission pattern.

16. The method of claim 15, wherein the case includes a front side and a rear side, and wherein the mobile terminal includes at least one camera positioned in at least one of the front side and the rear side of the case, the method further comprising:
capturing an image using the at least one camera, wherein the obtained information is color information from the captured image, and wherein controlling the operation of the at least one optical output unit is based on the color information.

17. The method of claim 16, wherein the color information is based on the color of a person's clothing in the captured image.

18. The method of claim 16, wherein controlling the operation of the at least one optical output unit further comprises changing the light emission color to another color within the same series as the color according to the color information.

19. The method of claim 16, wherein the mobile terminal includes a first camera and a first optical output unit in the front side of the case and a second camera and a second optical output unit in the rear side of the case, and wherein capturing the image comprises:
capturing a first image with the first camera; and
capturing a second image with the second camera, and wherein controlling the at least one optical output unit comprises:
changing the light emission color of the first optical output unit based on color information associated with the first image; and
changing the light emission color of the second optical output unit based on color information associated with the second image.

20. The method of claim 15, wherein the mobile terminal includes a display, and wherein controlling the at least one optical output unit further comprises controlling the light emission when the obtained information satisfies a specific condition, regardless of the display operation.

21. The method of claim 15, wherein the mobile terminal includes a display, the method further comprising:
displaying the obtained information on the display when a user manipulation of the mobile terminal is sensed and the at least one optical output unit is operating.

22. The method of claim 15, wherein the obtained information is at least one of stock information, weather information and information concerning the health of a user of the mobile terminal.

23. The method of claim 15, wherein the obtained information is a set amount of time, and wherein controlling light emission duration is based on the set amount of time.

24. The method of claim 15, wherein controlling light emission color comprises controlling the at least one optical output unit to emit a different one of a plurality of colors based on the obtained information.

25. The method of claim 24, wherein the obtained information relates to the occurrence of a specific event.
